(19) United States
(12) Patent Application Publication
(10) Pub. No.: US 2024/0135231 A1
(43) Pub. Date: Apr. 25, 2024

(54) REINFORCEMENT LEARNING-BASED ENHANCED DISTRIBUTED CHANNEL ACCESS

(71) Applicant: QUALCOMM Incorporated, San Diego, CA (US)

(72) Inventors: Gaurang Naik, San Diego, CA (US); George Cherian, San Diego, CA (US); Sai Yiu Duncan Ho, San Diego, CA (US); Yanjun Sun, San Diego, CA (US); Abhishek Pramod Patil, San Diego, CA (US); Alfred Asterjadhi, San Diego, CA (US); Abdel Karim Ajami, Lakeside, CA (US)

(21) Appl. No.: 17/969,591

(22) Filed: Oct. 18, 2022

(51) Int. Cl. G06N 20/00

(52) U.S. Cl. CPC G06N 20/00

(57) ABSTRACT

This disclosure provides methods, components, devices and systems for use of a reinforcement learning (RL) model to obtain one or more parameters associated with a channel access procedure. Some aspects more specifically relate to mechanisms according to which a wireless communication device may receive information associated with the RL model and transmit a protocol data unit (PDU) during a slot that is based on an output of the model. The wireless communication device may use the RL model to perform a distributed channel access procedure in accordance with the information and may further transmit the PDU, during the slot that is based on the output of the RL model, in accordance with the distributed channel access procedure. The information associated with the RL model may indicate or configure the RL model or may indicate whether the wireless communication is allowed to retrain the RL model.

### TECHNICAL FIELD

The following relates to wireless communications, including reinforcement learning (RL)-based enhanced distributed channel access (EDCA).

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a WLAN, such as a Wi-Fi (Such as Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a wireless communication device. The method may include receiving information associated with a reinforcement learning model, where the reinforcement learning model is associated with performing a distributed channel access procedure at the wireless communication device in a wireless local area network in accordance with the information and transmitting a protocol data unit in accordance with the distributed channel access procedure and during a slot that is based on an output of the reinforcement learning model.

Another innovative aspect of the subject matter described in this disclosure can be implemented in an apparatus for wireless communication at a wireless communication device. The apparatus may include a processor, memory coupled with the processor, and instructions stored in the memory. The instructions may be executable by the processor to cause the apparatus to receive information associated with a reinforcement learning model, where the reinforcement learning model is associated with performing a distributed channel access procedure at the wireless communication device in a wireless local area network in accordance with the information and transmit a protocol data unit in accordance with the distributed channel access procedure and during a slot that is based on an output of the reinforcement learning model.

Another innovative aspect of the subject matter described in this disclosure can be implemented in another apparatus for wireless communication at a wireless communication device. The apparatus may include means for receiving information associated with a reinforcement learning model, where the reinforcement learning model is associated with performing a distributed channel access procedure at the wireless communication device in a wireless local area network in accordance with the information and means for transmitting a protocol data unit in accordance with the distributed channel access procedure and during a slot that is based on an output of the reinforcement learning model.

Another innovative aspect of the subject matter described in this disclosure can be implemented in a non-transitory computer-readable medium storing code for wireless communication at a wireless communication device. The code may include instructions executable by a processor to receive information associated with a reinforcement learning model, where the reinforcement learning model is associated with performing a distributed channel access procedure at the wireless communication device in a wireless local area network in accordance with the information and transmit a protocol data unit in accordance with the distributed channel access procedure and during a slot that is based on an output of the reinforcement learning model.

In some examples of the method, apparatuses, and non-transitory computer-readable medium described herein, receiving the information associated with the reinforcement learning model may include operations, features, means, or instructions for receiving an indication that the wireless communication device may be allowed to develop the reinforcement learning model and use the reinforcement learning model for the distributed channel access procedure.

In some examples of the method, apparatuses, and non-transitory computer-readable medium described herein, receiving the information associated with the reinforcement learning model may include operations, features, means, or instructions for receiving information associated with the reinforcement learning model and an indication of whether the wireless communication device may be allowed to retrain the reinforcement learning model for the distributed channel access procedure, the method further including and selectively retraining the reinforcement learning model based on whether the wireless communication device may be allowed to retrain the reinforcement learning model.

In some examples of the method, apparatuses, and non-transitory computer-readable medium described herein, receiving the information associated with the reinforcement learning model may include operations, features, means, or instructions for receiving an indication that the wireless communication device may be allowed to retrain the reinforcement learning model for the distributed channel access procedure, where the reinforcement learning model may be pre-loaded at the wireless communication device, the method further including and retraining the reinforcement learning model based on the wireless communication device being allowed to retrain the reinforcement learning model.

In some examples of the method, apparatuses, and non-transitory computer-readable medium described herein, receiving the information associated with the reinforcement learning model may include operations, features, means, or instructions for receiving an indication of a policy associated with training or retraining the reinforcement learning model, the method further including and training or retraining the reinforcement learning model in accordance with the policy.

One innovative aspect of the subject matter described in this disclosure can be implemented in a method for wireless communication at a wireless communication device. The method may include transmitting information associated with a reinforcement learning model, where the reinforcement learning model is associated with performing a distributed channel access procedure at a second wireless communication device in a wireless local area network in accordance with the information and receiving, from the second wireless communication device, a protocol data unit in accordance with the distributed channel access procedure and during a slot that is based on an output of the reinforcement learning model.

Another innovative aspect of the subject matter described in this disclosure can be implemented in an apparatus for wireless communication at a wireless communication device. The apparatus may include a processor, memory coupled with the processor, and instructions stored in the memory. The instructions may be executable by the processor to cause the apparatus to transmit information associated with a reinforcement learning model, where the reinforcement learning model is associated with performing a distributed channel access procedure at a second wireless communication device in a wireless local area network in accordance with the information and receive, from the second wireless communication device, a protocol data unit in accordance with the distributed channel access procedure and during a slot that is based on an output of the reinforcement learning model.

Another innovative aspect of the subject matter described in this disclosure can be implemented in another apparatus for wireless communication at a wireless communication device. The apparatus may include means for transmitting information associated with a reinforcement learning model, where the reinforcement learning model is associated with performing a distributed channel access procedure at a second wireless communication device in a wireless local area network in accordance with the information and means for receiving, from the second wireless communication device, a protocol data unit in accordance with the distributed channel access procedure and during a slot that is based on an output of the reinforcement learning model.

Another innovative aspect of the subject matter described in this disclosure can be implemented in a non-transitory computer-readable medium storing code for wireless communication at a wireless communication device. The code may include instructions executable by a processor to transmit information associated with a reinforcement learning model, where the reinforcement learning model is associated with performing a distributed channel access procedure at a second wireless communication device in a wireless local area network in accordance with the information and receive, from the second wireless communication device, a protocol data unit in accordance with the distributed channel access procedure and during a slot that is based on an output of the reinforcement learning model.

In some examples of the method, apparatuses, and non-transitory computer-readable medium described herein, transmitting the information associated with the reinforcement learning model may include operations, features, means, or instructions for transmitting an indication that the second wireless communication device may be allowed to develop the reinforcement learning model and use the reinforcement learning model for the distributed channel access procedure.

In some examples of the method, apparatuses, and non-transitory computer-readable medium described herein, transmitting the information associated with the reinforcement learning model may include operations, features, means, or instructions for transmitting information associated with the reinforcement learning model and an indication of whether the second wireless communication device may be allowed to retrain the reinforcement learning model for the distributed channel access procedure.

In some examples of the method, apparatuses, and non-transitory computer-readable medium described herein, transmitting the information associated with the reinforcement learning model may include operations, features, means, or instructions for transmitting an indication that the second wireless communication device may be allowed to retrain the reinforcement learning model for the distributed channel access procedure, where the reinforcement learning model may be pre-loaded at the second wireless communication device.

In some examples of the method, apparatuses, and non-transitory computer-readable medium described herein, transmitting the information associated with the reinforcement learning model may include operations, features, means, or instructions for transmitting an indication of a policy associated with training or retraining the reinforcement learning model.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that supports reinforcement learning (RL)-based enhanced distributed channel access (EDCA) in accordance with aspects of the present disclosure.

FIG. 2 shows an example signaling diagram that supports RL-based EDCA in accordance with one or more aspects of the present disclosure.

FIG. 3 shows an example RL model that supports RL-based EDCA in accordance with one or more aspects of the present disclosure.

FIGS. 4 and 5 show example RL procedures that support RL-based EDCA in accordance with one or more aspects of the present disclosure.

FIG. 6 shows an example process flow that supports RL-based EDCA in accordance with one or more aspects of the present disclosure.

FIG. 7 shows a flowchart illustrating an example process performable by a wireless AP that supports RL-based EDCA in accordance with one or more aspects of the present disclosure.

FIG. 8 shows a flowchart illustrating an example process performable by a wireless STA that supports RL-based EDCA in accordance with one or more aspects of the present disclosure.

FIGS. 9 and 10 show block diagrams of example wireless communication devices that support RL-based EDCA in accordance with one or more aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In some Wi-Fi systems, one or more devices may contend for channel access in accordance with a channel access technique, such as enhanced distributed channel access (EDCA). EDCA may be associated with two primary parameters, including a contention window (CW) and a backoff (BO) counter. In accordance with EDCA, a device may initialize a CW to a minimum value (such as CWₘᵢₙ), select a random BO (RBO) within a range of [0, CWmin−1], decrement the RBO by 1 for each slot that the device senses to be idle, and, when RBO=0, perform a transmission. If the transmission fails, the device may set the CW to a smaller of twice the previously used CW and a maximum value (such as CWₘₐₓ). If a subsequent transmission attempt is successful, the device may re-initialize CW to the minimum value (such as CWₘᵢₙ). In other words, the device may double CW each time a transmission fails and may reset to a minimum CW value once a transmission is successful. As such, a likelihood for the device to keep a CW near an “optimal” CW (which may be understood as a CW that has a high likelihood of facilitating a successful transmission while maintaining a suitable latency) is relatively low, unless the optimal CW duration is the minimum CW value. Instead, the device may have a high likelihood of scaling up CW toward the optimal CW value by first experiencing one or more transmission failures. Such a channel access design may introduce latency and may be associated with relatively low spectral efficiency and data rates.

Various aspects of the present disclosure relate generally to a use of a reinforcement learning (RL) model associated with a channel access procedure to communicate a protocol data unit (PDU). Some aspects more specifically relate to one or more configuration- or signaling-based mechanisms according to which a wireless communication device may receive information associated with the RL model and transmit a PDU during a slot that is based on an output of the model. In some implementations, the wireless communication device, which may be an example of a station (STA), may use the RL model to perform a distributed channel access procedure in accordance with the information and may further transmit the PDU, during the slot that is based on the output of the RL model, in accordance with the distributed channel access procedure. By supporting such an RL model that is associated with performing the distributed channel access procedure, the wireless communication device may have a higher likelihood of keeping a CW that facilitates successful transmission while maintaining suitable latency, relative to doubling CW each time a transmission fails and resetting to a minimum CW value once a transmission is successful as described above, which may result in lower latency, higher data rates, greater spectral efficiency, and lower power consumption.

Particular aspects of such subject matter can be implemented to realize one or more of the following potential advantages. In some implementations, by supporting such an RL model that is associated with performing the distributed channel access procedure, the wireless communication device may use the RL to obtain, identify, select, or otherwise determine relatively more optimal channel access parameters than the wireless communication device may otherwise use in a non-RL model-based channel access procedure. For example, in accordance with using the RL model that is associated with the distributed channel access procedure, the wireless communication device may sense or identify a slot during which to transmit that is relatively more likely to result in a successful transmission from the wireless communication device. As such, the wireless communication device may experience fewer transmission failures, which may result in lower latency, higher data rates, greater spectral efficiency, and lower power consumption.

Various further aspects of the present disclosure relate to the information the wireless communication device may receive that is associated with the RL model. In some implementations, the information may include an indication that the wireless communication device is allowed to develop the RL model at the wireless communication device and, once the RL model is developed, use the RL model for the distributed channel access procedure. Additionally, or alternatively, the wireless communication device may be configured with the RL model via the information, such that the information may indicate the complete RL model or various aspects of the RL model. Additionally, or alternatively, the wireless communication device may receive an indication of whether the wireless communication device is allowed to retrain the RL model or an indication of what parameters the wireless communication device may use the RL model to obtain.

Aspects of such subject matter also can be implemented to realize one or more of the following potential advantages. For example, in accordance with supporting signaling mechanisms according to which the wireless communication device may receive indications of how the wireless communication device is allowed or expected to use the RL model, a network controller, such as an access point (AP), may enable use of RL models for channel access in a controlled manner. As such, a network deployment may balance the lower latency, higher data rates, greater spectral efficiency, and lower power consumption associated with use of the RL model with channel access fairness. For example, the network controller may restrict the wireless communication device from retraining the RL model to avoid a scenario in which the wireless communication device dominates channel access over other, non-RL-capable devices. Alternatively, the network controller may enable the wireless communication device to retrain the RL model in deployments in which all local devices are RL-capable, such that the devices may compete for channel on equal ground. Accordingly, a network employing such signaling mechanisms may balance RL-based channel access effectiveness with network-wide channel access fairness to ensure that various device types are able to receive service.

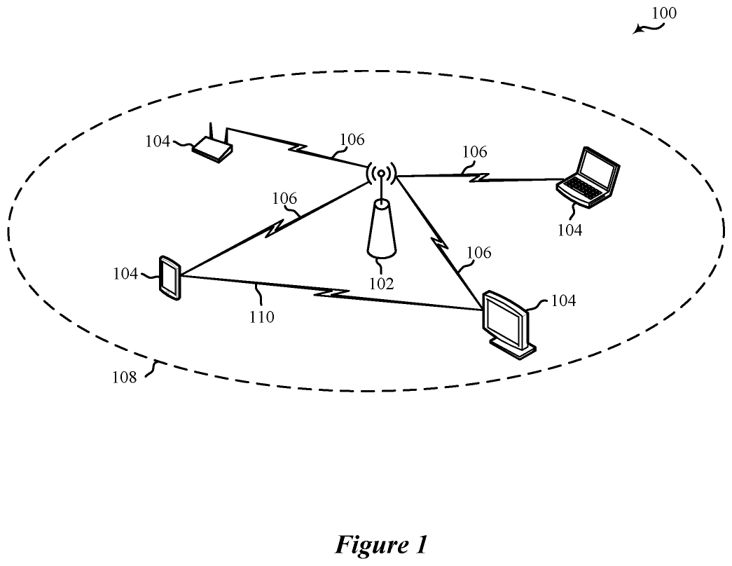

FIG. 1 shows a pictorial diagram of an example wireless communication network 100 that supports RL-based EDCA in accordance with aspects of the present disclosure. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE or 5G NR can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (such as TVs (including smart TVs), computer monitors, navigation systems, among others), music or other audio or stereo devices, remote control devices (“remotes”), printers, kitchen appliances (including smart refrigerators) or other household appliances, key fobs (such as for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium at the particular time. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TxOP and may begin transmitting. The TxOP is the duration of time the wireless communication device can transmit frames over the channel after it has “won” contention for the wireless medium. The TxOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TxOP, it randomly selects a new backoff timer duration. The available distribution of the numbers that may be randomly selected for the backoff timer is referred to as the contention window (CW). There are different CW and TxOP durations for each of the four access categories (ACs): voice (AC_VO), video (AC_VI), background (AC_BK), and best effort (AC_BE). This enables particular types of traffic to be prioritized in the network.

Some APs 102 and STAs 104 may implement spatial reuse techniques. For example, APs 102 and STAs 104 configured for communications using IEEE 802.11ax or 802.11be may be configured with a BSS color. APs 102 associated with different BSSs may be associated with different BSS colors. A BSS color is a numerical identifier of an AP's respective BSS (such as a 6 bit field carried by the SIG field). Each STA 104 may learn its own BSS color upon association with the respective AP. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA, the AP 102 or STA 104 may use a first received signal strength indication (RSSI) detection threshold when performing a CCA on the wireless channel. However, if the BSS color associated with the wireless packet is different than the BSS color of the AP 102 or STA, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

In some deployments, the WLAN 100, or devices of the WLAN 100, may support reinforced learning, such as via artificial intelligence (AI) or machine learning (ML). Such AI/ML-capable devices of the WLAN 100 may employ AI/ML-based operations across one or more various use implementations, including for optimizing, improving, or otherwise facilitating 802.11 features. As described herein, RL may perform a task based on a given set of states, actions, and rewards. For example, given a system that includes an agent that interacts with the environment along with states, actions, and rewards, a wireless communication device (such as an AP 102 or a STA 104) may learn a policy (such as learn a mapping from a state to an action). The agent may learn through experience, such as by taking or performing an action and observing rewards or updated states. Examples of RL models may include deep Q networks (DQNs), policy gradient, actor-critic techniques, contextual multi-armed bandit (MAB), or context-less MAB, among other examples.

States may be a representation of a current environment, such as a current environment associated with a task. In other words, a set of one or more states may inform an RL agent of information associated with a current situation. An action may be something an RL agent may perform to change one or more states. A reward may be associated with a utility of the RL agent for performing “correct” actions. For example, states may inform an RL agent of a current situation and rewards may signal or be associated with the states that the RL agent may aspire towards. Accordingly, given a set of one or more states, one or more actions, and one or more rewards, an RL agent may learn a policy, which may refer to a function according to which one or more actions may be performed in each of various states to increase (e.g., maximize) a reward. In an example RL procedure, an RL agent may perform a first action based on a first state and may receive a first reward associated with performing the first action from the first state. The RL agent may also identify a second state based on performing the first action from the first state, may perform a second action based on the second state, and may receive a second reward associated with performing the second action from the second state. The RL agent may track the first reward and the second reward and may learn which actions from which states results in increases to the reward.

As more devices are capable of RL functionality, such as AI or ML algorithms, some networks may leverage RL to select, identify, calculate, estimate, or otherwise determine one or more channel access parameters. For example, a wireless communication may use an output of an RL model to obtain one or more parameters associated with channel access and may use the one or more parameters as part of a channel access procedure. In some implementations, the wireless communication may use RL-based (such as RL-determined) parameters as part of a network-supported channel access procedure, such as an EDCA procedure, or may use RL-based parameters to bypass a network-supported channel access procedure.

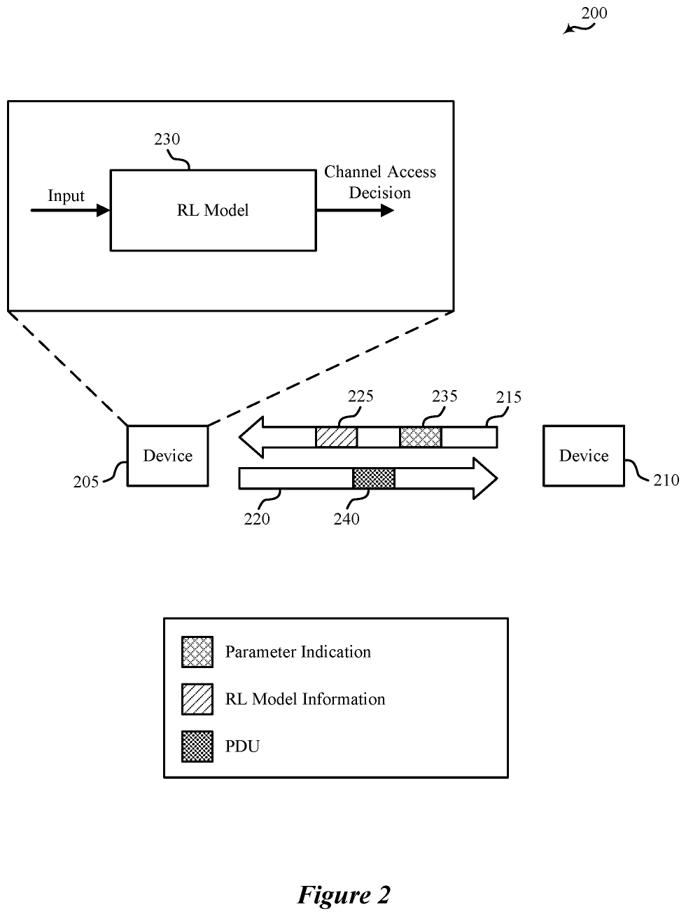

FIG. 2 illustrates an example of a signaling diagram 200 that supports RL-based EDCA in accordance with one or more aspects of the present disclosure. The signaling diagram 200 may implement or be implemented to realize or facilitate aspects of the WLAN 100. For example, the signaling diagram 200 illustrates communication between a device 205 and a device 210, which may be examples of devices illustrated by and described with reference to FIG. 1. For example, the device 205 may be an example of an AP 102 or a STA 104. Similarly, the device 210 may be an example of an AP 102 or a STA 104. In some implementations, the device 205 and the device 210 may support one or more configuration- or signaling-based mechanisms according to which the device 205 may conditionally leverage some or all AI/ML capabilities of the device 205 in accordance with signaling from the device 210. The device 210 may transmit signaling to the device 205 via a communication link 215 and the device 205 may transmit signaling to the device 210 via a communication link 220.

In some scenarios, one or more devices, which may be examples of 802.11 devices, may attempt to acquire channel access. In some implementations, the one or more devices may use an EDCA protocol to access a wireless medium. In such implementations, each device may maintain a CW and a BO counter for each of a set of access categories (AC). For example, a device may support one or more ACs. In some implementations, a device may support four ACs including voice (VO), video (VI), best effort (BE), and background (BK). Different access categories may be associated with different priorities. For example, voice may be associated with a highest priority, video a second highest priority, best effort a third highest priority, and background a lowest priority.

As part of an EDCA protocol to access a wireless medium, a device may initialize a CW to CWₘᵢₙ and select a BO uniformly in [0, CWₘᵢₙ−1]. During each idle slot, a device may decrement BO by 1 and, if BO=0, the device may transmit. If the transmission fails, a device may set CW=min(2*CW, CWₘₐₓ). If the transmission succeeds, a device may re-initialize CW to CWₘᵢₙ. In other words, a device may double a CW each time a transmission fails and may reset to a minimum CW value once a transmission is successful. As such, a likelihood for a device to keep a CW duration near an “optimal” CW duration may be relatively low. For a given network configuration, a selection of an “optimal” CW value may result in relatively fewer collisions (such as minimum collisions). A network configuration may relate to or include a quantity of STAs 104 in a BSS, a quantity of overlapping BSSs, or a traffic load, among other aspects.

Instead of being able to keep a CW duration near an “optimal” CW duration, devices (such as 802.11 devices) may hover around an optimal value through the EDCA protocol, but most of the times the devices may pick a sub-optimal value for a CW duration. For example, if an optimal CW=2⁴*CWₘᵢₙ for a given network, the EDCA protocol may take four collisions for a device to scale up to such a CW value. Further, after every successful transmission, the CW value is reset to CWₘᵢₙ. As such, devices may take four more collisions to reach this value after each successful transmission, which will result in relatively long latency. For further, example, if CW=25 is the optimal CW value for a given network, a device may never actually be able to use CW=25 in accordance with the EDCA protocol, as CW values are calculated or selected in powers of 2.

Accordingly, in some implementations, the device 205 may use an RL-based model to determine or make channel access decisions. In other word, the device 205 may support an AI/ML capability to control channel access in some networks, such as in 802.11 networks. In some implementations, to support and facilitate RL-based channel access, the device 210 may transmit RL model information 225 to the device 205. The RL model information 225 may include information associated with an RL model 230, which the device 205 may use to determine or make one or more channel access decisions. A content of the RL model information 225 may vary by implementation or deployment scenario. In some aspects, the device 210 may generate and transmit the RL model information 225 as part of controlling the use of the RL model 230 (such as AI/ML) in a BSS or to support one or more available options for model generation and usage, or both.

In some implementations, for example, the device 205 that uses the RL model 230 for channel access may use RL to develop the RL model 230 from scratch (such as through experience) and may derive interference from the RL model 230. In such implementations, the RL model information 225 may include an indication that the device 205 is allowed to develop its own RL model 230. Additionally, or alternatively, the device 205 may use a downloaded RL model 230 from another STA (such as the device 210) as-is and may use the downloaded RL model 230 to derive inferences. For example, the device 205 may download the RL model 230 from the device 210 (such as an AP 102) and may use the RL model 230 for inference. In such implementations in which the device 205 downloads the RL model 230 from the device 210, the RL model information 225 may include the complete RL model 230 (such as an algorithm associated with the RL model 230) and may further indicate whether the device 205 is allowed to retrain the RL model 230. In some implementations, the RL model information 225 may indicate that the device 205 is not allowed to retrain the RL model 230. In some other examples, the RL model information 225 may indicate that the device 205 is allowed to retrain the RL model 230. In such examples, the device 205 may perform retraining (such as refining) of a downloaded RL model 230 from another STA (such as the device 210) and may use the RL model 230 for inference. In other words, the device 205 may download the RL model 230 from the device 210 (such as an AP 102) and may use experience (such as transitions) to refine the RL model 230 along with using the model for inference.

Additionally, or alternatively, the device 205 may use a local pre-trained RL model 230 as-is (such as without retraining). For example, the device 205 may be shipped with a pre-trained RL model 230 and the device 205 may use the RL model 230 for inference without tuning the RL model 230. In such implementations, the RL model information 225 may indicate that the device 205 is allowed to use the pre-trained RL model 230. In some implementations, such as in implementations in which the device 205 is equipped with multiple pre-trained RL models, the RL model information 225 may indicate the RL model 230 from the multiple pre-trained RL models equipped at the device 205. In some implementations, the device 205 may use RL to perform retraining (such as refining) of a pre-trained model 230. For example, the device 205 may be shipped with a pre-trained RL model 230 and may use experience to refine the RL model 230 along with using the RL model 230 for inference. In such implementations, the RL model information 225 may indicate that the device 205 is allowed to use the pre-trained RL model 230 and may further indicate that the device 205 is allowed to retrain or refine the pre-trained RL model 230.

In some implementations, the device 210 (such as a controlling entity) in the BSS may allow usage of ML models (such as the RL model 230) that the device 210 downloads to STAs 104. For example, different RL models at different STAs 104 may result in different channel access probabilities, which may lead to unfairness. Accordingly, in such implementations, the device 210 may include, in the RL model information 225, an indication that the device 205 is allowed to use an RL model 230 indicated by the device 210 and is not allowed to use other RL models 230 in a BSS. In some implementations, the device 210 (such as a controlling entity in the BSS) may not allow a tuning of a downloaded RL model 230. For example, tuning RL models may lead to different channel access probabilities at different STAs 104, which may result in unfairness. Accordingly, in such implementations, the device 205 and the device 210 may support downloading the RL model 230 with no retraining being allowed in the BSS.

In some other implementations, the device 210 (such as a controlling entity) may allow tuning a downloaded RL model 230 in a specific, controlled way. For example, the device 210 may advertise values of parameters associated with an RL technique, which may be referred to as hyperparameters, or a policy that can be used to tune the RL model 230. Such hyperparameters may include one or more of β, γ, ε, where β may be a learning rate, γ may be a discount factor, and ε may be a parameter associated with an ε-greedy policy. In some aspects, a learning rate may determine to what extent newly acquired information overrides old information (where a factor of 0 may result in an agent learning nothing and a factor of 1 may result in an agent only considering most recent information), a discount factor may determine an importance of future rewards (where a discount factor of 0 may result in an agent only considering current rewards and a factor approaching 1 may result in the an agent striving for a long-term high reward), and ε may be associated with a probability (e.g., a probability of (1−ε)) an action corresponding to a highest Q-value is selected. For example, the device 210 may indicate, via the RL model information 225, that an ε-greedy policy (and only an ε-greedy policy) can be used to retrain or tune the RL model 230. In some implementations, the device 210 may advertise a criteria under which a controlled entity (such as the device 205) may initiate a retraining of the RL model 230. In other words, the device 205 may retrain the RL model 230 if one or more conditions or criteria are satisfied, where the device 210 may indicate such conditions or criteria via the RL model information 225.

In some aspects, a set of available options for RL-based training or retraining of the RL model 230 may be indicated via the RL model information 225. An available policy during training or retraining may be one of random, random within a range (e.g., a transmission probability may be uniformly random in (0.2, 0.7)), greedy, ε-greedy, Boltzmann (such as Softmax), or EDCA protocol. In implementations in which the training or retraining policy is an EDCA protocol, when the RL model 230 is not used for deriving inference, the device 205 may use an EDCA protocol, but the transitions eₜ=(Sₜ, Sₜ₊₁, Aₜ, Rₜ) may be stored and used to train the RL model 230 (such as a DQN). In some implementations, the device 210 also may indicate, via the RL model information 225, a set of available or allowed policies during inference. In some aspect, the device 210 may indicate, to the device 205, that a policy during inference may be greedy.

Accordingly, in some implementations, the device 205 may use the RL model 230 for channel access inference (such as for one or more decisions associated with channel access). In accordance with an inference at the device 205, an expectation may be that an agent (such as an AI/ML-associated agent of the device 205) may be in possession of the RL model 230, such as a Q-table. In an example implementation of the RL model 230 for channel access in which the RL model 230 is a Q-table, the agent may compute a state Sₜ=[S_{t,0}, S_{t,1}, S_{t,2}] and the agent may select an action in accordance with α=argmaxₐ Q(Sₜ, a), where the action selection strategy may be greedy (such as the device 205 may select the action with the highest Q-value). The agent may compute CW=2^{α}*CWₘᵢₙ, select an RBO uniformly in [0, CW−1]. In other words, the device 205 may use the RL model to obtain a channel access parameter α as an output and may use the channel access parameter α to calculate a CW value. In some aspects, the parameter α may be referred to as a CW stage. The device may freeze a countdown of RBO if the measured or sensed medium is busy and may count down (such as decrement) RBO for each idle slot and transmit when RBO=0. For example, the device 205 may transmit a PDU 240 when RBO=0.

Additionally, or alternatively, the device 205 may use the RL model 230 to obtain one or more other channel access parameters. In other words, the device 205 may derive one or more actions from an output of the RL model 230, and the actions may be in terms of one or more channel access parameters. In some implementations, for example, the device 205 may obtain a transmission probability (such as 0<p_{T}<1) in an idle slot based on the output of the RL model 230. In such implementations, the device 205 may obtain p_{T} from the RL model 230 in accordance with a set of states and, if a slot is idle, the device 205 may transmit the PDU 240 with a probability of p_{T}. Likewise, the device 205 may have a probability of (1−p_{T}) of waiting for a next idle slot. Additionally, or alternatively, the device 205 may obtain an RBO value to choose after a PPDU transmission based on an output of the RL model 230. For example, the output of the RL model 230 may directly give an RBO value and the device 205 may use the RBO value during an EDCA procedure accordingly. Additionally, or alternatively, the device 205 may obtain a CW value to choose after a PPDU transmission based on an output of the RL model 230. For example, the output of the RL model 230 may directly give the CW value and the device 205 may use the CW value during an EDCA procedure accordingly. Additionally, or alternatively, the device 205 may obtain a set of a parameters α, T based on an output of the RL model 230 such that CW=T^{α}*CWₘᵢₙ. For example, the device 205 may use CW=T^{α}*CWₘᵢₙ to compute a CW value during an EDCA procedure. In some implementations, the device 210 may indicate, to the device 205, which parameter(s) the device 205 may use the RL model 230 to obtain via the RL model information 225.

The agent may determine a reward (such as rₜ) based on a success or failure of the PPDU transmission and the agent may store the reward in a reward buffer. The agent may compute a next state Sₜ₊₁=[S_{t+1,0}, S_{t+1,1}, S_{t+1,2}] and may store the experience eₜ=(Sₜ, Sₜ₊₁, Aₜ, Rₜ). In some implementations, the agent may refrain from updating the RL model 230 (such as the Q-table) and may repeat such steps for a next PPDU transmission. In accordance with using the RL model 230 to obtain a channel access decision, the device 205 may support conditional retraining. For example, an expectation may be that the agent is in possession of a trained Q-table and, during inference, the agent keeps track of an average reward in the reward buffer. If the average reward buffer is less than a threshold reward (such as less than Γ), the agent may initiate retraining of the RL model 230. In some aspects, retraining may be performed similarly as an initial training procedure, except that, during retraining, the initial Q-table is not all 0's. Instead, the initial Q-table is the current Q-table.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The device 205 may derive one or more rewards from one or more of various communication parameters, which may be measured, calculated, or determined at the device 205 or may be indicated to the device 205 from the device 210. Such communication parameters may include a throughput metric, a delay metric, a quantity of collisions, a packet/frame delivery ratio, or a packet/frame loss ratio. In some aspects, a throughput metric may refer to an observed throughput over a last time period, such as over a last 10 seconds. In some aspects, a delay metric may refer to a mean or specific percentile delay observed for a last specific quantity of aggregated MAC PDUs (A-MPDUs). For example, the delay metric may be a mean or 95th percentile delay observed for a last 100 A-MPDUs. In some aspects, a quantity of collisions may refer to a fraction of a last specific quantity of transmissions that resulted in collisions, and may be indicated by the device 210 (such as an AP 102). For example, the quantity of collisions may refer to a fraction of a last 100 transmissions that resulted in collisions. In some aspects, a packet/frame delivery ratio may refer to a ratio of successful packets/frames to a total quantity of transmitted packets/frames within a given time interval. In some aspects, a packet/frame loss ratio may refer to an inverse of the packet/frame delivery ratio.

In some implementations, the states that the device 205 may use as inputs into the RL model 230 may include one or more parameters associated with an environment of the device 205. The device 205 may measure, determine, or calculate one or more of the state parameters or may receive (such as from the device 210) an indication of one or more of the state parameters, or any combination thereof. In some aspects, the device 205 may receive an indication of one or more state parameters from the device 210 via a parameter indication 235. The states may include one or more of a faction of a last ‘X’ transmissions that were successful, a fraction of a last ‘X’ transmissions that resulted in collisions, a quantity of interruptions during an RBO countdown, a quantity of channel busy periods within a last ‘Y’ seconds, a quantity of idle periods within a last ‘Y’ seconds, a quantity of unique receiver address (RA) field values observed within a specific time window, a quantity of unique transmitter address (TA) field values observed with a specific time window, a quantity of non-ML STAs 104 in the BSS, or a quantity of active STAs 104 (such as a quantity of contenders, which may be indicated by the device 210). In some aspects, a generation or determination of the quantity of non-ML STAs 104 in the BSS may be associated with the device 210 transmitting an indication of a list of MAC addresses that are ML capable, the device 205 observing a variant of one or more A-control fields, or ML-based STAs 104 using different (such as reserved for others) values for one or more specific fields (such as a BSS color field).

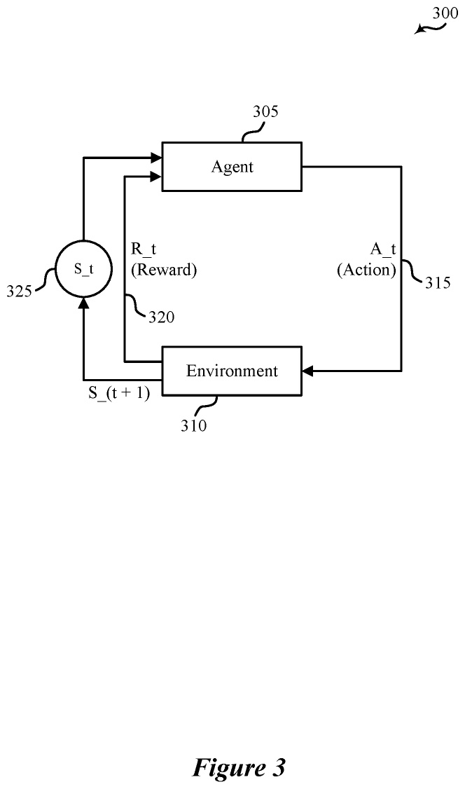

FIG. 3 illustrates an example of an RL model 300 that supports RL-based EDCA in accordance with one or more aspects of the present disclosure. The RL model 300 may implement or be implemented to realize or facilitate aspects of the WLAN 100 or the signaling diagram 200. For example, a device 205, as illustrated by and described with reference to FIG. 2, may employ the RL model 300 to obtain an output associated with one or more channel access parameters or decisions. For further example, the RL model 300 may be an example of the RL model 230 as illustrated by and described with reference to FIG. 2.

The RL model 300 includes an agent 305 that may interact with an environment 310. For example, the RL model 300 may be a decision making model associated with channel access, and may interact with the environment to output decisions associated with channel access. In some implementations, the agent 305 may output information associated with an action 315 (such as an Aₜ) based on a reward 320 (such as Rₜ) and a state 325 (such as Sₜ). The action 315 may interact with, influence, or be influenced by the environment 310 to result in an updated state 325 (such as Sₜ₊₁) and a fresh reward 320. The device 205 may employ the RL model 300 to obtain an output associated with a channel access procedure and, in some implementations, may be allowed to retrain or refine the RL model 300.

To describe an RL algorithm, various components of the RL model 300 may be defined. Such components of the RL model 300 may include an RL technique, the states 325, the action 315, a policy, the reward 320, and an inference procedure. In some aspects, given an RL technique, training the RL model 300 may follow any supported procedure. In some implementations, the RL technique may a Q learning, a deep Q learning, or a double Q learning technique according to which the device 205 (or the agent 305) learns the Q-values for state-action pairs. In some other implementations, the RL technique may be a policy grant (such as REINFORCE) according to which the device 205 (or the agent 305) learns the policy. In some other implementations, the RL technique may be an actor-critic technique (such as AC, A2C, or A3C) according to which the device 205 (or the agent 305) learns Q-values as well as policy. In some other implementations, the RL technique may be a contextual MAB or context-less MAB. As described herein, contexts may be the same as states and context-less MABs may not base an associated policy on an observation of states (such as the RL model 300 does not take the state 325 as an input).

In accordance with the example implementations described herein, an AP 102 may offer downloadable trained RL models 300 for use by one or more STAs 104. Further, in some implementations, a STA 104 may send one or more of the state variables to a peer STA 104 for computing an updated state 325. In such implementations, an AP 102 may transmit an indication of a quantity of non-ML STAs in the BSS or a quantity of active contenders, or both, to an ML STA 104 (such as the device 205). In some implementations, the AP 102 may include the indication in an A-Control subfield. Additionally, or alternatively, a STA 104 may piggyback (such as include or multiplex) an acknowledgement (ACK) with information related to a failure cause of one or more MPDUs. Such information related to a failure cause may indicate, for example, that a cause of failure is a poor choice of modulation and coding scheme (MCS) or a collision. Further, in some implementations, a first STA 104 may send one or more of the rewards 320 to a second STA 104 to aid the first STA 104 in training or retraining an RL model 300. For example, an AP 102 may piggyback (such as include or multiplex) information related to a signal-to-interference-plus-noise ratio (SINR) of a received PPDU.

Further, in some implementations, an AP 102 may change one or more EDCA values or parameters for non-ML STAs 104 based on how many ML devices and non-ML devices are within a given geographic area. For example, if a given area is associated with one or more ML devices that are allowed to use an RL model for channel access, an AP 102 may adjust or modify one or more EDCA values for a non-ML STA 104 to facilitate fair channel access probabilities for the non-ML STA 104. In other words, the AP 102 may adjust or modify the one or more EDCA values or parameters to make the non-ML STA 104 more competitive with STAs 104 that are allowed to use ML-based channel access.

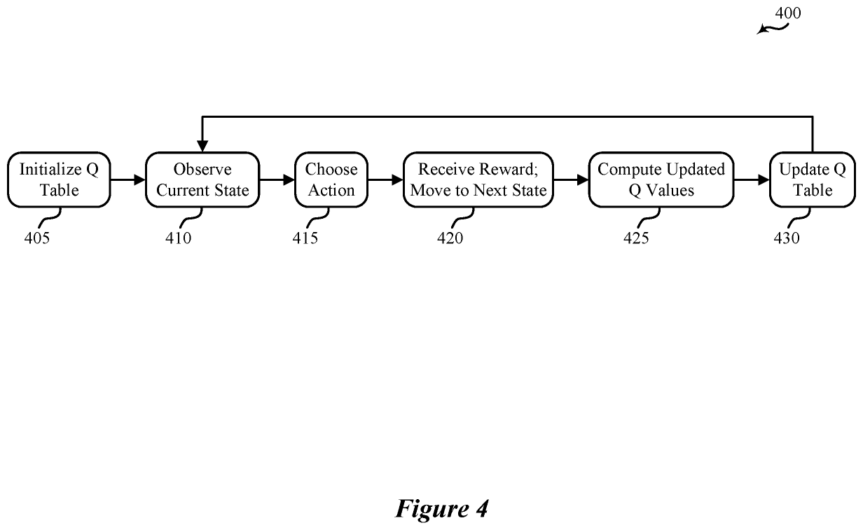

FIG. 4 illustrates an example of an RL procedure 400 that supports RL-based EDCA in accordance with one or more aspects of the present disclosure. The RL procedure 400 may implement or be implemented to realize or facilitate aspects of the WLAN 100, the signaling diagram 200, or the RL model 300. For example, a device 205 (such as an AP 102 or a STA 104) may perform the RL procedure 400 as part of a Q learning procedure. In some implementations, the device 205 may perform the RL procedure 400 to train or retrain the RL model 230 or the RL model 300 as illustrated by and described with reference to FIGS. 2 and 3.

At 405, the device 205 may initialize a Q-table. For example, the device 205 may initialize a Q-table to zeros, such that each (state, action) pair is associated with a Q-value of 0. An example initialized Q-table is illustrated below by Table 1.

TABLE 1
Example Initialized Q-Table

| | A₀ | A₁ | . . . | A_{K} |
|---|---|---|---|---|
| S₀ | 0 | 0 | . . . | 0 |
| S₁ | 0 | 0 | . . . | 0 |
| . . . | . . . | . . . | . . . | . . . |
| S_{M} | 0 | 0 | . . . | 0 |

At 410, the device 205 may observe a current state, which may be denoted as Sₜ. For example, the device 205 may observe a current state Sₜ of an environment of the device 205.

At 415, the device 205 may select an action Aₜ and perform a corresponding function. In some aspects, performing the corresponding function of an action Aₜ may be referred to as “playing.” For example, the action Aₜ may be selected by a random, greedy, ε-greedy, or Boltzmann (Softmax) policy. A Boltzmann (Softmax) policy may be described by

$$p ( a ) = \frac{{e}^{{Q}_{t} ( a ) / τ}}{{\sum }_{b = 1}^{n} {e}^{{Q}_{t} ( b ) / τ}} ,$$

where Q may be a Q-value and τ is a temperature factor which may determine the probability of executing actions other than those with the highest Q-value.

At 420, the device 205 may receive a reward Rₜ and move to the next state Sₜ₊₁.

At 425, the device 205 may use a Bellman Equation to compute updated Q-values. The Bellman Equation may be of the form Q(Sₜ,Aₜ)=(1−β)Q(Sₜ,Aₜ)+β*(Rₜ+λ*maxₐ Q(Sₜ₊₁, a)), Q(Sₜ,Aₜ)=Q(Sₜ,Aₜ)+β*(Rₜ+λ*maxₐ Q(Sₜ₊₁, a)−Q(Sₜ,Aₜ)), or Q(Sₜ,Aₜ)=(1−α) Q(Sₜ,Aₜ)+α*(Rₜ+λ*maxₐ Q(Sₜ₊₁, a)), or any combination thereof, where Q may be a Q-value, β may be a learning rate, S may be a state, A may be an action, R may be a reward, and α may be a CW stage.

At 430, the device 205 may update the Q-table. An example updated Q-table is shown in Table 2. The device may repeat the RL procedure 400 beginning at 410.

TABLE 2
Example Updated Q-Table

| | A₀ | A₁ | . . . | Aⱼ | . . . | A_{K} |
|---|---|---|---|---|---|---|
| S₀ | Q(S₀, A₀) | Q(S₀, A₁) | . . . | Q(S₀, Aⱼ) | . . . | Q(S₀, A_{K}) |
| S₁ | Q(S₁, A₀) | Q(S₁, A₁) | . . . | Q(S₁, Aⱼ) | . . . | Q(S₁, A_{K}) |
| . . . | . . . | . . . | . . . | . . . | . . . | . . . |
| Sⱼ | Q(Sⱼ, A₀) | Q(Sⱼ, A₁) | . . . | Q(Sⱼ, Aⱼ) | . . . | Q(Sⱼ, A_{K}) |
| . . . | . . . | . . . | . . . | . . . | . . . | . . . |
| S_{M} | Q(S_{M}, A₀) | Q(S_{M}, A₁) | . . . | Q(S_{M}, Aⱼ) | . . . | Q(S_{M}, A_{K}) |

As described herein, components of RL may include an agent, environment, state, actions, reward, and policy. In the example of an RL technique of Q learning, an agent may be a STA 104 that learns the RL model and environment (which may be an 802.11 network). A state may be a vector of three observations. In an example, a first observation may include a quantity of interruptions in a latest or most recent RBO countdown, a second observation may include a quantity of unique TA fields observed in a last or most recent 5 seconds, and a third observation may include a quantity of a last 10 PPDUs for which a STA 104 receives an ACK. The action may be to select an α such that CW=2^{α}*CWₘᵢₙ. The action space may be {0, 1, 2, . . . , K}, where K may be defined such that CWₘₐₓ=2^{K}*CWₘᵢₙ. In some implementations, the reward may be an inverse of an average latency of one or more MPDUs in the transmitted PPDUs, where the reward may be equal to 0 if a PPDU transmission fails. In some implementations, a policy may be ε-greedy during training and greedy during inference. For ε-greedy policy, an agent may select an action with a highest Q-value with a probability of (1−ε). With probability ε, the agent may select one of the other actions uniformly. For example, if there are K+1 actions and one action has a highest Q-value, an agent may select one of the other K actions with a probably of ε/K each.

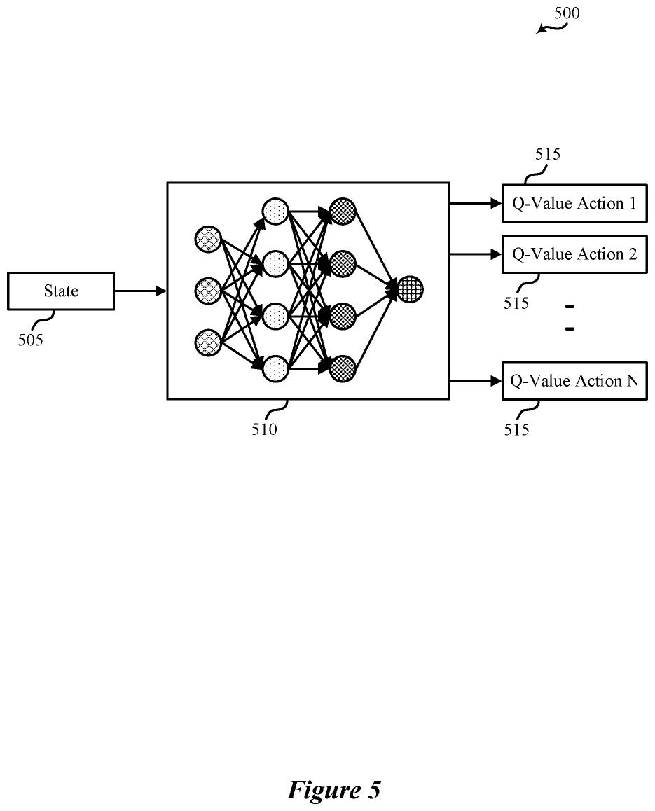

FIG. 5 illustrates an example of an RL procedure 500 that supports RL-based EDCA in accordance with one or more aspects of the present disclosure. The RL procedure 500 may implement or be implemented to realize or facilitate aspects of the WLAN 100, the signaling diagram 200, the reinforcement learning model 300, or the RL procedure 400. For example, a device 205 (such as an AP 102 or a STA 104) may perform the RL procedure 500 as part of a deep Q learning (DQN) procedure. In such examples, the device 205 may learn, derive, generate, or otherwise approximate a Q-table using a state 505 as an input into a neural network 510, which may output a set of one or more Q-value actions 515, including a Q-value action 1, a Q-value action 2, and so on to a Q-value action N.

The state 505 may be associated with or include one or more observations. For example, the state 505 may be associated with or include a first observation (such as a state s₀), a second observation (such as a state s₁), and a third observation (such as a state s₃). Further, in such examples, the one or more Q-value actions 515 may include a Q(α=0) value, a Q(α=1) value, and so on up to a Q(α=K) value.

For example, an agent may have an untrained RL model at a first time which may be represented by t=0. The state 505 may be represented by S₀=[S₀₁, S₀₂, . . . , S_{0M}]. Initially, the agent may pick a random action and a value for both a learning rate β and a discount factor γ. At each time, which may be represented by t≥0, the agent my perform an action task. During the action task, the agent may choose an action Aₜ according to a policy. The agent may receive a reward Rₜ and move to the next step Sₜ₊₁. The agent also may record a transition experience eₜ=(Sₜ, Sₜ₊₁, Aₜ, Rₜ) and store it in a buffer.

At each time t≥0, the agent also may perform a learning task. During the learning task, the agent may compute a loss L, which may be represented by L=(Q_{Target}−Q(sₜ,Aₜ))², where Q_{Target}=Rₜ+γmaxₐQ(Sₜ₊₁, a). The agent may compute a gradient of the loss, which may be represented by ∂L/∂Φ, where Φ may be a deep neural network (DNN) parameter. The agent may backpropagate the gradient to minimize the loss. For example, a previous DNN parameter Φ′ may be updated to be represented by Φ′+β*∂L/∂Φ. If Q_{Target} is considered the true label and Q(Sₜ,Aₜ) is the predicted label, the learning may be the same as DNNs for supervised learning. This learning procedure may imitate the temporal difference Bellman equation used at 425. The learning rate β may decay over time, if, for example, the agent has more experience and therefore uses smaller parameter updates. After sufficient iterations, the DQN model learned by the agent may provide a sufficiently accurate representation of a converged Q-table. The resulting DQN may be referred to as a trained model and may be used for channel access.

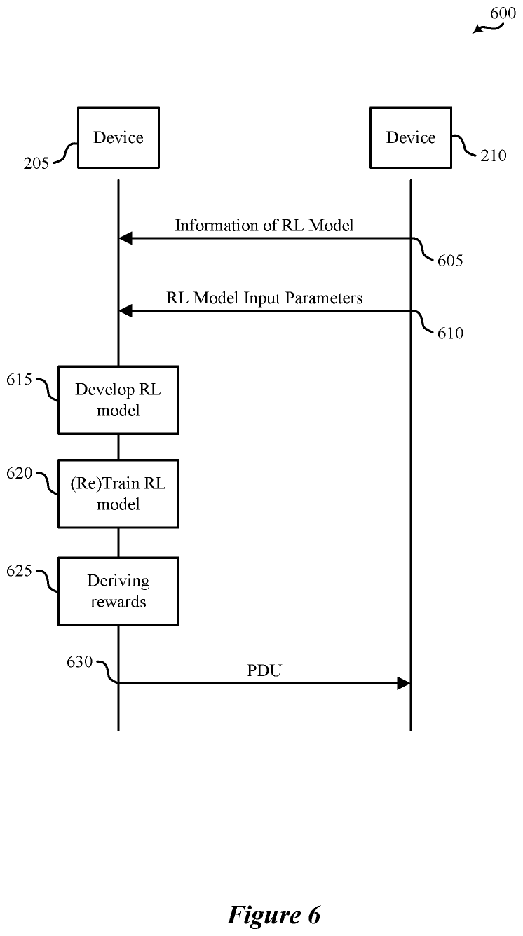

FIG. 6 illustrates an example of a process flow 600 that supports RL-based EDCA in accordance with one or more aspects of the present disclosure. The process flow 600 may implement or be implemented to realize aspects of the WLAN 100, the signaling diagram 200, the RL model 300, the RL procedure 400, or the RL procedure 500. For example, the process flow 600 illustrates communication between the device 205 and the device 210, which are illustrated by and described with reference to FIG. 2.

In the following description of the process flow 600, the operations may be performed (such as reported or provided) in a different order than the order shown, or the operations performed by the example devices may be performed in different orders or at different times. For example, specific operations also may be left out of the process flow 600, or other operations may be added to the process flow 600. Further, although some operations or signaling may be shown to occur at different times for discussion purposes, these operations may actually occur at the same time.

At 605, the device 205 may receive, from the device 210, information associated with an RL model. In some implementations, the RL model may be associated with performing a distributed channel access procedure at the device 205 in a WLAN in accordance with the information. The information associated with the RL model may include various content in accordance with a decision at a controlling entity (such as the device 210). In some implementations, the information may include an indication that the device 205 is allowed (e.g., permitted or authorized) to develop the RL model and use the RL model for the distributed channel access procedure. In some implementations, the information may include a configuration of the RL model and an indication of whether the device 205 is allowed to retrain the RL model. In some implementations, the information may include an indication that the device 205 is allowed to retrain the RL model for the distributed channel access procedure, where the RL model may be pre-loaded or pre-configured at the device 205.

In some implementations, the information may include an indication of which channel access parameters the device 205 may use the RL model to determine. In some implementations, the information may include an indication of one or more parameters, such as one or more hyperparameters, associated with an RL technique that the device 205 is to follow when training or retraining the RL model. In some implementations, the information may include an indication of one or more rewards associated with the RL model. In such implementations, for example, the device 210 may indicate what rewards the device 205 may obtain from the RL model, may indicate an upper limit associated with one or more rewards (e.g., to control a potential retraining of the RL model by the device 205), or any combination thereof.

In some implementations, the information may include an indication of a policy that the device may use for training or retraining the RL model. Example policies may include one or more of random, random within a range (e.g., uniformly random within a specified range), greedy, ε-greedy, Boltzmann (such as Softmax), or EDCA protocol. Further, a policy may refer to or be associated with how the device 205 (e.g., an agent of an RL model used by the device 205) maps states to actions or learns to map states to actions to increase (e.g., maximize) one or more rewards.

At 610, the device 205 may receive, from the device 210, an indication of one or more parameters associated with an environment of the device 205. In some implementations, the output of the RL model may be associated with a use of the one or more parameters as inputs into the RL model. The one or more parameters include one or more of a fraction of a most recent set of PDUs that were successfully transmitted, a fraction of the most recent set of PDUs that resulted in collisions, a quantity of interruptions during an RBO countdown during the distributed channel access procedure, a quantity of channel busy periods during a most recent time period, a quantity of channel idle periods during the most recent time period, a quantity of unique RA field values observed during a time window, a quantity of unique TA field values observed during the time window, a quantity of devices within a BSS that are incapable of using reinforcement learning for channel access, or a quantity of active devices within the BSS.

At 615, the device 205 may develop the RL model. For example, if the device 210 indicates that the device 205 is allowed to develop the RL model, the device 205 may develop the RL model. In some aspects, developing the RL model may be equivalently understood as initially creating the RL model (e.g., initially training or learning the RL model). For example, if a RL model has not yet been created or configured for device 205, the device 210 may indicate to device 205 to develop or initially create the model (e.g., based on information communicated at 605 and/or 610). Device 205 may initially develop the RL model, rather than receiving the RL model or an indication of the RL model, for use based on the information communicated at 605 and/or 610.

At 620, the device 205 may (re)train the RL model. For example, if the device 210 indicates that the device 205 is allowed to train or retrain (such as refine) the RL model, the device 210 may (re)train the RL model. Generally, the device 205 may selectively train or retrain the RL model in accordance with whether the device 210 indicates whether the device 205 is allowed to train or retrain the RL model.

At 625, the device 205 may derive one or more rewards associated with the RL model in accordance with one or more communication parameters associated with communication to or from the device 205. In some implementations, the device 205 may derive the one or more rewards in accordance with one or more of a SINR, a throughput metric, a delay metric, a quantity of collisions, a ratio between a quantity of successful PDU transmissions and a total quantity of PDU transmissions, or a ratio between a quantity of unsuccessful PDU transmissions and the total quantity of PDU transmissions. The device 205 may store the one or more rewards in a reward buffer and, in some aspects, may track an average reward over time. In some implementations, if the device 205 is allowed, the device 205 may trigger a retraining of the RL model if the average reward fails to satisfy a threshold. In some implementations, the rewards that the device 205 derives may be associated with the initial training or development of the RL model.

At 630, the device 205 may perform the distributed channel access procedure (in accordance with a type of the output of the RL model) and may transmit a PDU during a slot that is based on the output of the RL model. For example, the device 205 may obtain, as an output of the RL model, a transmission probability, an RBO value, a CW duration, or values of one or more parameters (e.g., values of one or both of a or T) via which the device 205 may calculate a CW duration and the device 205 may identify a slot during which to transmit the PDU in accordance with any of such outputs of the RL model. In some implementations, the device 205 may identify the slot during which to transmit the PDU in accordance with achieving a suitable reward associated with the RL model, where such a suitable reward may be achieved during an initial development or a retraining of the RL model at one or both of the device 205 and the device 210. In some implementations, the device 205 may use outputs of the RL model to make channel access decisions for one or multiple transmissions. For example, the device 205 may always be allowed to use the RL model for channel access decision making or may be allowed to use the RL model for channel access decision making at specified times or under specified conditions (e.g., as indicated by the device 210).

Further, as described herein, a slot that is based on the output of the RL model may be selected, identified, or otherwise used for the transmission of the PDU in various ways depending on a type of the output of the RL model. For example, if the RL model outputs a transmission probability, the slot may be based on the output of the RL model in accordance with an actual transmission of the PDU during that slot being associated with the transmission probability. For further example, if the RL model outputs an RBO counter value, the slot may be based on the output of the RL model in accordance with the device 205 transmitting the PDU once RBO=0 (e.g., in accordance with an EDCA protocol), where an RBO counter value of 0 may be associated with a specific slot based on an original value of the RBO counter and a quantity of busy slots from a start of a CW. For further example, if the RL model outputs a CW duration or values of one or parameters via which the device 205 may calculate a CW duration, the slot may be based on the output of the RL model in accordance with the device 205 transmitting the PDU during a slot that is within the CW duration. Further, the device 205 may transmit the PDU in accordance with the distributed channel access procedure by transmitting the PDU when an RBO counter value is equal to 0 or based on otherwise transmitting the PDU during a slot that is sensed to be idle (e.g., not busy or used by another device).

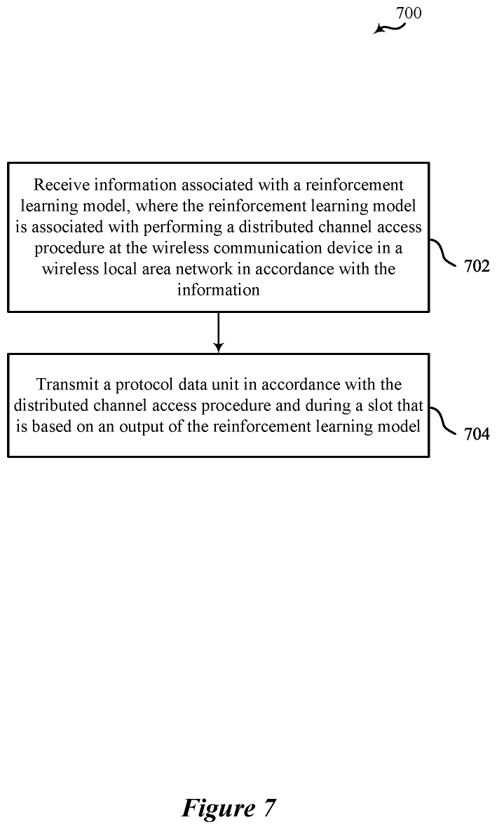

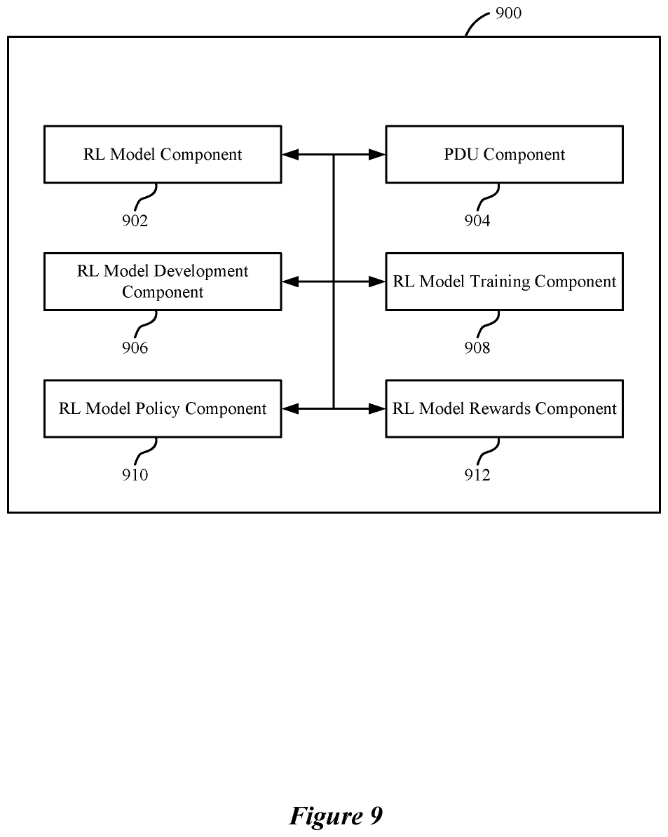

FIG. 7 shows a flowchart illustrating an example process 700 performable at a wireless STA that supports RL-based EDCA in accordance with one or more aspects of the present disclosure. The operations of the process 700 may be implemented by a wireless STA or its components as described herein. For example, the process 700 may be performed by a wireless communication device, such as the wireless communication device 900 described with reference to FIG. 9, operating as or within a wireless STA. In some implementations, the process 700 may be performed by a wireless STA such as one of the STAs 104 described with reference to FIG. 1.

At 702, the method may include receiving information associated with a reinforcement learning model, where the reinforcement learning model is associated with performing a distributed channel access procedure at the wireless communication device in a wireless local area network in accordance with the information. The operations of 705 may be performed in accordance with examples as disclosed herein.

At 704, the method may include transmitting a protocol data unit in accordance with the distributed channel access procedure and during a slot that is based on an output of the reinforcement learning model. The operations of 704 may be performed in accordance with examples as disclosed herein.

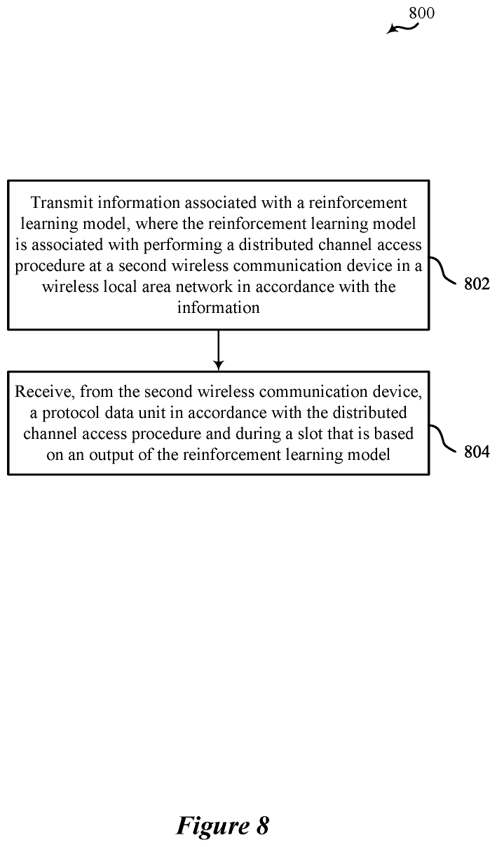

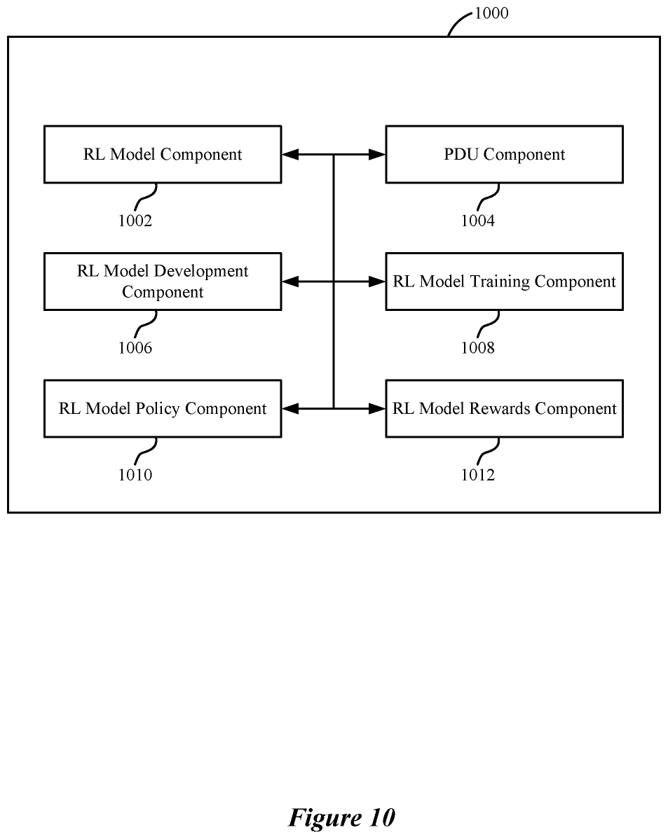

FIG. 8 shows a flowchart illustrating an example process 800 performable at a wireless AP that supports RL-based EDCA in accordance with one or more aspects of the present disclosure. The operations of the process 800 may be implemented by a wireless AP or its components as described herein. For example, the process 800 may be performed by a wireless communication device, such as the wireless communication device 1000 described with reference to FIG. 10, operating as or within a wireless AP. In some implementations, the process 800 may be performed by a wireless AP such as one of the APs 102 described with reference to FIG. 1.

At 802, the method may include transmitting information associated with a reinforcement learning model, where the reinforcement learning model is associated with performing a distributed channel access procedure at a second wireless communication device in a wireless local area network in accordance with the information. The operations of 802 may be performed in accordance with examples as disclosed herein.

At 804, the method may include receiving, from the second wireless communication device, a protocol data unit in accordance with the distributed channel access procedure and during a slot that is based on an output of the reinforcement learning model. The operations of 804 may be performed in accordance with examples as disclosed herein.

FIG. 9 shows a block diagram of an example wireless communication device 900 that supports RL-based EDCA according to some aspects of the present disclosure. In some implementations, the wireless communication device 900 is configured or operable to perform the process 700 described with reference to FIG. 7. In various examples, the wireless communication device 900 can be a chip, SoC, chipset, package or device that may include: one or more modems (such as, a Wi-Fi (IEEE 802.11) modem or a cellular modem such as 3GPP 4G LTE or 5G compliant modem), one or more processors, processing blocks or processing elements (collectively “the processor”); one or more radios (collectively “the radio”); and one or more memories or memory blocks (collectively “the memory”).

In some implementations, the wireless communication device 900 can be a device for use in a STA, such as STA 104 described with reference to FIG. 1. In some other examples, the wireless communication device 900 can be a STA that includes such a chip, SoC, chipset, package or device as well as multiple antennas. The wireless communication device 900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 900 also includes or can be coupled with an application processor which may be further coupled with another memory. In some implementations, the wireless communication device 900 further includes a user interface (UI) (such as a touchscreen or keypad) and a display, which may be integrated with the UI to form a touchscreen display. In some implementations, the wireless communication device 900 may further include one or more sensors such as, for example, one or more inertial sensors, accelerometers, temperature sensors, pressure sensors, or altitude sensors.

The wireless communication device 900 includes an RL model component 902, a PDU component 904, an RL model development component 906, an RL model training component 908, an RL model policy component 910, and an RL model rewards component 912. Portions of one or more of the components 902, 904, 906, 908, 910 and 912 may be implemented at least in part in hardware or firmware. For example, the PDU component 904 may be implemented at least in part by a modem. In some implementations, at least some of the components 902, 904, 906, 908, 910 and 912 are implemented at least in part by a processor and as software stored in a memory. For example, portions of one or more of the components 902, 904, 906, 908, 910 or 912 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 900). For example, a processing system of the device 900 may refer to a system including the various other components or subcomponents of the device 900, such as the processor, or a transceiver, or a communications manager, or other components or combinations of components of the device 900. The processing system of the device 900 may interface with other components of the device 900, and may process information received from other components (such as inputs or signals) or output information to other components. For example, a chip or modem of the device 900 may include a processing system, a first interface to output information and a second interface to obtain information. In some implementations, the first interface may refer to an interface between the processing system of the chip or modem and a transmitter, such that the device 900 may transmit information output from the chip or modem. In some implementations, the second interface may refer to an interface between the processing system of the chip or modem and a receiver, such that the device 900 may obtain information or signal inputs, and the information may be passed to the processing system. A person having ordinary skill in the art will readily recognize that the first interface also may obtain information or signal inputs, and the second interface also may output information or signal outputs.

The RL model component 902 may be capable of, configured to, or operable to receive information associated with a reinforcement learning model, where the reinforcement learning model is associated with performing a distributed channel access procedure at the wireless communication device in a wireless local area network in accordance with the information. The PDU component 904 may be capable of, configured to, or operable to transmit a protocol data unit in accordance with the distributed channel access procedure and during a slot that is based on an output of the reinforcement learning model.

In some implementations, to support receiving the information associated with the reinforcement learning model, the RL model development component 906 may be capable of, configured to, or operable to receive an indication that the wireless communication device is allowed to develop the reinforcement learning model and use the reinforcement learning model for the distributed channel access procedure.

In some implementations, the RL model development component 906 may be capable of, configured to, or operable to develop the reinforcement learning model at the wireless communication device in accordance with receiving the indication that the wireless communication device is allowed to develop the reinforcement learning model.

In some implementations, to support receiving the information associated with the reinforcement learning model, the RL model component 902 may be capable of, configured to, or operable to receive a configuration associated with the reinforcement learning model and an indication of whether the wireless communication device is allowed to retrain the reinforcement learning model for the distributed channel access procedure, the method further including. In some implementations, to support receiving the information associated with the reinforcement learning model, the RL model training component 908 may be capable of, configured to, or operable to selectively retrain the reinforcement learning model based on whether the wireless communication device is allowed to retrain the reinforcement learning model.

In some implementations, to support receiving the information associated with the reinforcement learning model, the RL model training component 908 may be capable of, configured to, or operable to receive an indication that the wireless communication device is allowed to retrain the reinforcement learning model for the distributed channel access procedure, where the reinforcement learning model is pre-loaded at the wireless communication device, the method further including. In some implementations, to support receiving the information associated with the reinforcement learning model, the RL model training component 908 may be capable of, configured to, or operable to retrain the reinforcement learning model based on the wireless communication device being allowed to retrain the reinforcement learning model.

In some implementations, the RL model component 902 may be capable of, configured to, or operable to receive an indication that the wireless communication device is allowed to use the reinforcement learning model to obtain one or more of a transmission probability, a backoff counter, a duration of a contention window, or one or more parameters associated with the duration of the contention window, where the output of the reinforcement learning model includes the transmission probability, the backoff counter, the duration of a contention window, or the one or more parameters associated with the duration of the contention window.

In some implementations, to support receiving the information associated with the reinforcement learning model, the RL model policy component 910 may be capable of, configured to, or operable to receive an indication of a policy associated with training or retraining the reinforcement learning model, the method further including. In some implementations, to support receiving the information associated with the reinforcement learning model, the RL model training component 908 may be capable of, configured to, or operable to train or retrain the reinforcement learning model in accordance with the policy.

In some implementations, the policy includes an enhanced distributed channel access protocol or a distributed coordination function protocol. In some implementations, one or more parameters associated with a use of the enhanced distributed channel access protocol or the distributed coordination function protocol are stored in a buffer of the wireless communication device. In some implementations, training or retraining the reinforcement learning model is based on the one or more parameters.

In some implementations, to support receiving the information associated with the reinforcement learning model, the RL model component 902 may be capable of, configured to, or operable to receive an indication of one or more parameters associated with a reinforcement learning technique that the wireless communication device is to follow when training or retraining the reinforcement learning model, where the reinforcement learning technique is associated with a Q learning technique, a policy gradient, an actor-critic technique, or a contextual multi-armed bandit (MAB) or context-less MAB technique, the method further including. In some implementations, to support receiving the information associated with the reinforcement learning model, the RL model training component 908 may be capable of, configured to, or operable to train or retrain the reinforcement learning model in accordance with the one or more parameters associated with the reinforcement learning technique.

In some implementations, to support transmitting the protocol data unit in accordance with the distributed channel access procedure and during the slot that is based on the output of the reinforcement learning model, the PDU component 904 may be capable of, configured to, or operable to attempt to transmit the protocol data unit during one or more idle slots in accordance with a transmission probability, where the transmission probability is the output of the reinforcement learning model.

In some implementations, to support transmitting the protocol data unit in accordance with the distributed channel access procedure and during the slot that is based on the output of the reinforcement learning model, the PDU component 904 may be capable of, configured to, or operable to transmit the protocol data unit during the slot in accordance with an expiration of a backoff counter, where the backoff counter is the output of the reinforcement learning model.

In some implementations, to support transmitting the protocol data unit in accordance with the distributed channel access procedure and during the slot that is based on the output of the reinforcement learning model, the PDU component 904 may be capable of, configured to, or operable to transmit the protocol data unit during a contention window, where a duration of the contention window is associated with the output of the reinforcement learning model.

In some implementations, the output of the reinforcement learning model includes an absolute value of the duration of the contention window or one or more parameters associated with a multiplier factor. In some implementations, the duration of the contention window is equal to a product of a minimum contention window duration and the multiplier factor.

In some implementations, to support receiving the information associated with the reinforcement learning model, the RL model rewards component 912 may be capable of, configured to, or operable to receive an indication of one or more rewards associated with the reinforcement learning model, where the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, where the output of the reinforcement learning model is based at least in part on the one or more rewards.

In some implementations, the one or more rewards are stored in a reward buffer associated with the reinforcement learning model.

In some implementations, the RL model rewards component 912 may be capable of, configured to, or operable to derive one or more rewards associated with the reinforcement learning model in accordance with one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, where the output of the reinforcement learning model is based at least in part on the one or more rewards.

In some implementations, one or more updated parameters associated with an environment of the wireless communication device are calculated based on transmitting the protocol data unit in accordance with the distributed channel access procedure. In some implementations, the one or more updated parameters are stored at the wireless communication device. In some implementations, a potential retraining of the reinforcement learning model is associated with the one or more updated parameters.

In some implementations, the RL model component 902 may be capable of, configured to, or operable to identify an updated state associated with the wireless communication device in accordance with transmitting the protocol data unit. In some implementations, the RL model component 902 may be capable of, configured to, or operable to input, into the reinforcement learning model, the updated state to obtain an updated output of the reinforcement learning model. In some implementations, the PDU component 904 may be capable of, configured to, or operable to transmit a second protocol data unit in accordance with the distributed channel access procedure and during a second slot that is based on the updated output of the reinforcement learning model.

In some implementations, the RL model component 902 may be capable of, configured to, or operable to receive an indication of one or more parameters associated with an environment of the wireless communication device, where the output of the reinforcement learning model is associated with a use of the one or more parameters as inputs into the reinforcement learning model.

In some implementations, the one or more parameters include one or more of a fraction of a most recent set of protocol data units that were successfully transmitted, a fraction of the most recent set of protocol data units that resulted in collisions, a quantity of interruptions during a random backoff countdown during the distributed channel access procedure, a quantity of channel busy periods during a most recent time period, a quantity of channel idle periods during the most recent time period, a quantity of unique receiver address field values observed during a time window, a quantity of unique transmitter address field values observed during the time window, a quantity of devices within a basic service set that are incapable of using reinforcement learning for channel access, or a quantity of active devices within the basic service set.

In some implementations, the reinforcement learning model is a decision-making model that is developed in accordance with interaction with an environment. In some implementations, the output of the reinforcement learning model includes a decision that is associated with channel access.

FIG. 10 shows a block diagram of an example wireless communication device 1000 that supports RL-based EDCA according to some aspects of the present disclosure. In some implementations, the wireless communication device 1000 is configured or operable to perform the process 800 described with reference to FIG. 8. In various examples, the wireless communication device 1000 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some implementations, the wireless communication device 1000 can be a device for use in an AP, such as AP 102 described with reference to FIG. 1. In some other examples, the wireless communication device 1000 can be an AP that includes such a chip, SoC, chipset, package or device as well as multiple antennas. The wireless communication device 1000 is capable of transmitting and receiving wireless communications in the form of, for example, wireless packets. For example, the wireless communication device 1000 can be configured or operable to transmit and receive packets in the form of physical layer PPDUs and MPDUs conforming to one or more of the IEEE 802.11 family of wireless communication protocol standards. In some implementations, the wireless communication device 1000 also includes or can be coupled with an application processor which may be further coupled with another memory. In some implementations, the wireless communication device 1000 further includes at least one external network interface that enables communication with a core network or backhaul network to gain access to external networks including the Internet.

The wireless communication device 1000 includes an RL model component 1002, a PDU component 1004, an RL model development component 1006, an RL model training component 1008, an RL model policy component 1010, and an RL model rewards component 1012, or any combination thereof. Portions of one or more of the components 1002, 1004, 1006, 1008, 1010 and 1012 may be implemented at least in part in hardware or firmware. For example, the PDU component 1004 may be implemented at least in part by a modem. In some implementations, at least some of the components 1002, 1004, 1006, 1008, 1010 and 1012 are implemented at least in part by a processor and as software stored in a memory. For example, portions of one or more of the components 1002, 1004, 1006, 1008, 1010 or 1012 can be implemented as non-transitory instructions (or “code”) executable by the processor to perform the functions or operations of the respective module

In some implementations, the processor may be a component of a processing system. A processing system may generally refer to a system or series of machines or components that receives inputs and processes the inputs to produce a set of outputs (which may be passed to other systems or components of, for example, the device 1000). For example, a processing system of the device 1000 may refer to a system including the various other components or subcomponents of the device 1000, such as the processor, or a transceiver, or a communications manager, or other components or combinations of components of the device 1000. The processing system of the device 1000 may interface with other components of the device 1000, and may process information received from other components (such as inputs or signals) or output information to other components. For example, a chip or modem of the device 1000 may include a processing system, a first interface to output information and a second interface to obtain information. In some implementations, the first interface may refer to an interface between the processing system of the chip or modem and a transmitter, such that the device 1000 may transmit information output from the chip or modem. In some implementations, the second interface may refer to an interface between the processing system of the chip or modem and a receiver, such that the device 1000 may obtain information or signal inputs, and the information may be passed to the processing system. A person having ordinary skill in the art will readily recognize that the first interface also may obtain information or signal inputs, and the second interface also may output information or signal outputs.

The RL model component 1002 may be capable of, configured to, or operable to transmit information associated with a reinforcement learning model, where the reinforcement learning model is associated with performing a distributed channel access procedure at a second wireless communication device in a wireless local area network in accordance with the information. The PDU component 1004 may be capable of, configured to, or operable to receive, from the second wireless communication device, a protocol data unit in accordance with the distributed channel access procedure and during a slot that is based on an output of the reinforcement learning model.

In some implementations, to support transmitting the information associated with the reinforcement learning model, the RL model development component 1006 may be capable of, configured to, or operable to transmit an indication that the second wireless communication device is allowed to develop the reinforcement learning model and use the reinforcement learning model for the distributed channel access procedure.

In some implementations, to support transmitting the information associated with the reinforcement learning model, the RL model component 1002 may be capable of, configured to, or operable to transmit information associated with the reinforcement learning model and an indication of whether the second wireless communication device is allowed to retrain the reinforcement learning model for the distributed channel access procedure.

In some implementations, to support transmitting the information associated with the reinforcement learning model, the RL model training component 1008 may be capable of, configured to, or operable to transmit an indication that the second wireless communication device is allowed to retrain the reinforcement learning model for the distributed channel access procedure, where the reinforcement learning model is pre-loaded at the second wireless communication device.

In some implementations, the RL model component 1002 may be capable of, configured to, or operable to transmit an indication that the second wireless communication device is allowed to use the reinforcement learning model to obtain one or more of a transmission probability, a backoff counter, a duration of a contention window, or one or more parameters associated with the duration of the contention window, where the output of the reinforcement learning model includes the transmission probability, the backoff counter, the duration of a contention window, or the one or more parameters associated with the duration of the contention window.

In some implementations, to support transmitting the information associated with the reinforcement learning model, the RL model policy component 1010 may be capable of, configured to, or operable to transmit an indication of a policy associated with training or retraining the reinforcement learning model.

In some implementations, the policy includes an enhanced distributed channel access protocol or a distributed coordination function protocol.

In some implementations, to support transmitting the information associated with the reinforcement learning model, the RL model component 1002 may be capable of, configured to, or operable to transmit an indication of one or more parameters associated with a reinforcement learning technique that the second wireless communication device is to follow when training or retraining the reinforcement learning model, where the reinforcement learning technique is associated with a Q learning technique, a policy gradient, an actor-critic technique, or a contextual multi-armed bandit (MAB) or context-less MAB technique.

In some implementations, to support transmitting the information associated with the reinforcement learning model, the RL model rewards component 1012 may be capable of, configured to, or operable to transmit an indication of one or more rewards associated with the reinforcement learning model, where the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, where the output of the reinforcement learning model is based at least in part on the one or more rewards.

In some implementations, the PDU component 1004 may be capable of, configured to, or operable to receive a second protocol data unit in accordance with the distributed channel access procedure and during a second slot that is based on an updated output of the reinforcement learning model.

In some implementations, the RL model component 1002 may be capable of, configured to, or operable to transmit an indication of one or more parameters associated with an environment of the second wireless communication device, where the output of the reinforcement learning model is associated with a use of the one or more parameters as inputs into the reinforcement learning model.

In some implementations, the one or more parameters include one or more of a fraction of a most recent set of protocol data units that were successfully transmitted, a fraction of the most recent set of protocol data units that resulted in collisions, a quantity of interruptions during a random backoff countdown during the distributed channel access procedure, a quantity of channel busy periods during a most recent time period, a quantity of channel idle periods during the most recent time period, a quantity of unique receiver address field values observed during a time window, a quantity of unique transmitter address field values observed during the time window, a quantity of devices within a basic service set that are incapable of using reinforcement learning for channel access, or a quantity of active devices within the basic service set.

In some implementations, the reinforcement learning model is a decision-making model that is developed in accordance with interaction with an environment. In some implementations, the output of the reinforcement learning model includes a decision that is associated with channel access.

Implementation examples are described in the following numbered clauses:

Clause 1: A method for wireless communication at a wireless communication device, comprising: receiving information associated with a reinforcement learning model, wherein the reinforcement learning model is associated with performing a distributed channel access procedure at the wireless communication device in a wireless local area network in accordance with the information; and transmitting a protocol data unit in accordance with the distributed channel access procedure and during a slot that is based at least in part on an output of the reinforcement learning model.

Clause 2: The method of clause 1, wherein receiving the information associated with the reinforcement learning model comprises: receiving an indication that the wireless communication device is allowed to develop the reinforcement learning model and use the reinforcement learning model for the distributed channel access procedure.

Clause 3: The method of clause 2, further comprising: developing the reinforcement learning model at the wireless communication device in accordance with receiving the indication that the wireless communication device is allowed to develop the reinforcement learning model.

Clause 4: The method of any of clauses 1 through 3, wherein receiving the information associated with the reinforcement learning model comprises: receiving information associated with the reinforcement learning model and an indication of whether the wireless communication device is allowed to retrain the reinforcement learning model for the distributed channel access procedure, the method further comprising: selectively retraining the reinforcement learning model based at least in part on whether the wireless communication device is allowed to retrain the reinforcement learning model.

Clause 5: The method of any of clauses 1 through 4, wherein receiving the information associated with the reinforcement learning model comprises: receiving an indication that the wireless communication device is allowed to retrain the reinforcement learning model for the distributed channel access procedure, wherein the reinforcement learning model is pre-loaded at the wireless communication device, the method further comprising: retraining the reinforcement learning model based at least in part on the wireless communication device being allowed to retrain the reinforcement learning model.

Clause 6: The method of any of clauses 1 through 5, further comprising: receiving an indication that the wireless communication device is allowed to use the reinforcement learning model to obtain one or more of a transmission probability, a backoff counter, a duration of a contention window, or one or more parameters associated with the duration of the contention window, wherein the output of the reinforcement learning model includes the transmission probability, the backoff counter, the duration of a contention window, or the one or more parameters associated with the duration of the contention window.

Clause 7: The method of any of clauses 1 through 6, wherein receiving the information associated with the reinforcement learning model comprises: receiving an indication of a policy associated with training or retraining the reinforcement learning model, the method further comprising: training or retraining the reinforcement learning model in accordance with the policy.

Clause 8: The method of clause 7, wherein the policy includes an enhanced distributed channel access protocol or a distributed coordination function protocol, one or more parameters associated with a use of the enhanced distributed channel access protocol or the distributed coordination function protocol are stored in a buffer of the wireless communication device, and training or retraining the reinforcement learning model is based at least in part on the one or more parameters.

Clause 9: The method of any of clauses 1 through 8, wherein receiving the information associated with the reinforcement learning model comprises: receiving an indication of one or more parameters associated with a reinforcement learning technique that the wireless communication device is to follow when training or retraining the reinforcement learning model, wherein the reinforcement learning technique is associated with a Q learning technique, a policy gradient, an actor-critic technique, or a contextual multi-armed bandit (MAB) or context-less MAB technique, the method further comprising: training or retraining the reinforcement learning model in accordance with the one or more parameters associated with the reinforcement learning technique.

Clause 10: The method of any of clauses 1 through 9, wherein transmitting the protocol data unit in accordance with the distributed channel access procedure and during the slot that is based at least in part on the output of the reinforcement learning model comprises: attempting to transmit the protocol data unit during one or more idle slots in accordance with a transmission probability, wherein the transmission probability is the output of the reinforcement learning model.

Clause 11: The method of any of clauses 1 through 10, wherein transmitting the protocol data unit in accordance with the distributed channel access procedure and during the slot that is based at least in part on the output of the reinforcement learning model comprises: transmitting the protocol data unit during the slot in accordance with an expiration of a backoff counter, wherein the backoff counter is the output of the reinforcement learning model.

Clause 12: The method of any of clauses 1 through 11, wherein transmitting the protocol data unit in accordance with the distributed channel access procedure and during the slot that is based at least in part on the output of the reinforcement learning model comprises: transmitting the protocol data unit during a contention window, wherein a duration of the contention window is associated with the output of the reinforcement learning model.

Clause 13: The method of clause 12, wherein the output of the reinforcement learning model includes an absolute value of the duration of the contention window or one or more parameters associated with a multiplier factor, and the duration of the contention window is equal to a product of a minimum contention window duration and the multiplier factor.

Clause 14: The method of any of clauses 1 through 13, wherein receiving the information associated with the reinforcement learning model comprises: receiving an indication of one or more rewards associated with the reinforcement learning model, wherein the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, wherein the output of the reinforcement learning model is based at least in part on the one or more rewards.

Clause 15: The method of clause 14, wherein the one or more rewards are stored in a reward buffer associated with the reinforcement learning model.

Clause 16: The method of any of clauses 1 through 15, further comprising: deriving one or more rewards associated with the reinforcement learning model in accordance with one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, wherein the output of the reinforcement learning model is based at least in part on the one or more rewards.

Clause 17: The method of any of clauses 1 through 16, wherein one or more updated parameters associated with an environment of the wireless communication device are calculated based at least in part on transmitting the protocol data unit in accordance with the distributed channel access procedure, the one or more updated parameters are stored at the wireless communication device, and a potential retraining of the reinforcement learning model is associated with the one or more updated parameters.

Clause 18: The method of any of clauses 1 through 17, further comprising: obtaining an updated state associated with the wireless communication device in accordance with transmitting the protocol data unit; inputting, into the reinforcement learning model, the updated state to obtain an updated output of the reinforcement learning model; and transmitting a second protocol data unit in accordance with the distributed channel access procedure and during a second slot that is based at least in part on the updated output of the reinforcement learning model.

Clause 19: The method of any of clauses 1 through 18, further comprising: receiving an indication of one or more parameters associated with an environment of the wireless communication device, wherein the output of the reinforcement learning model is associated with a use of the one or more parameters as inputs into the reinforcement learning model.

Clause 20: The method of clause 19, wherein the one or more parameters include one or more of a fraction of a most recent set of protocol data units that were successfully transmitted, a fraction of the most recent set of protocol data units that resulted in collisions, a quantity of interruptions during a random backoff countdown during the distributed channel access procedure, a quantity of channel busy periods during a most recent time period, a quantity of channel idle periods during the most recent time period, a quantity of unique receiver address field values observed during a time window, a quantity of unique transmitter address field values observed during the time window, a quantity of devices within a basic service set that are incapable of using reinforcement learning for channel access, or a quantity of active devices within the basic service set.

Clause 21: The method of any of clauses 1 through 20, wherein the reinforcement learning model is a decision-making model that is developed in accordance with interaction with an environment, and the output of the reinforcement learning model includes a decision that is associated with channel access.

Clause 22: A method for wireless communication at a wireless communication device, comprising: transmitting information associated with a reinforcement learning model, wherein the reinforcement learning model is associated with performing a distributed channel access procedure at a second wireless communication device in a wireless local area network in accordance with the information; and receiving, from the second wireless communication device, a protocol data unit in accordance with the distributed channel access procedure and during a slot that is based at least in part on an output of the reinforcement learning model.

Clause 23: The method of clause 22, wherein transmitting the information associated with the reinforcement learning model comprises: transmitting an indication that the second wireless communication device is allowed to develop the reinforcement learning model and use the reinforcement learning model for the distributed channel access procedure.

Clause 24: The method of any of clauses 22 through 23, wherein transmitting the information associated with the reinforcement learning model comprises: transmitting information associated with the reinforcement learning model and an indication of whether the second wireless communication device is allowed to retrain the reinforcement learning model for the distributed channel access procedure.

Clause 25: The method of any of clauses 22 through 24, wherein transmitting the information associated with the reinforcement learning model comprises: transmitting an indication that the second wireless communication device is allowed to retrain the reinforcement learning model for the distributed channel access procedure, wherein the reinforcement learning model is pre-loaded at the second wireless communication device.

Clause 26: The method of any of clauses 22 through 25, further comprising: transmitting an indication that the second wireless communication device is allowed to use the reinforcement learning model to obtain one or more of a transmission probability, a backoff counter, a duration of a contention window, or one or more parameters associated with the duration of the contention window, wherein the output of the reinforcement learning model includes the transmission probability, the backoff counter, the duration of a contention window, or the one or more parameters associated with the duration of the contention window.

Clause 27: The method of any of clauses 22 through 26, wherein transmitting the information associated with the reinforcement learning model comprises: transmitting an indication of a policy associated with training or retraining the reinforcement learning model.

Clause 28: The method of clause 27, wherein the policy includes an enhanced distributed channel access protocol or a distributed coordination function protocol.

Clause 29: The method of any of clauses 22 through 28, wherein transmitting the information associated with the reinforcement learning model comprises: transmitting an indication of one or more parameters associated with a reinforcement learning technique that the second wireless communication device is to follow when training or retraining the reinforcement learning model, wherein the reinforcement learning technique is associated with a Q learning technique, a policy gradient, an actor-critic technique, or a contextual multi-armed bandit (MAB) or context-less MAB technique.

Clause 30: The method of any of clauses 22 through 29, wherein transmitting the information associated with the reinforcement learning model comprises: transmitting an indication of one or more rewards associated with the reinforcement learning model, wherein the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, wherein the output of the reinforcement learning model is based at least in part on the one or more rewards.

Clause 31: The method of any of clauses 22 through 30, further comprising: receiving a second protocol data unit in accordance with the distributed channel access procedure and during a second slot that is based at least in part on an updated output of the reinforcement learning model.

Clause 32: The method of any of clauses 22 through 31, further comprising: transmitting an indication of one or more parameters associated with an environment of the second wireless communication device, wherein the output of the reinforcement learning model is associated with a use of the one or more parameters as inputs into the reinforcement learning model.

Clause 33: The method of clause 32, wherein the one or more parameters include one or more of a fraction of a most recent set of protocol data units that were successfully transmitted, a fraction of the most recent set of protocol data units that resulted in collisions, a quantity of interruptions during a random backoff countdown during the distributed channel access procedure, a quantity of channel busy periods during a most recent time period, a quantity of channel idle periods during the most recent time period, a quantity of unique receiver address field values observed during a time window, a quantity of unique transmitter address field values observed during the time window, a quantity of devices within a basic service set that are incapable of using reinforcement learning for channel access, or a quantity of active devices within the basic service set.

Clause 34: The method of any of clauses 22 through 33, wherein the reinforcement learning model is a decision-making model that is developed in accordance with interaction with an environment, and the output of the reinforcement learning model includes a decision that is associated with channel access.

Clause 35: An apparatus for wireless communication at a wireless communication device, comprising a processor; memory coupled with the processor; and instructions stored in the memory and executable by the processor to cause the apparatus to perform a method of any of clauses 1 through 21.

Clause 36: An apparatus for wireless communication at a wireless communication device, comprising at least one means for performing a method of any of clauses 1 through 21.

Clause 37: A non-transitory computer-readable medium storing code for wireless communication at a wireless communication device, the code comprising instructions executable by a processor to perform a method of any of clauses 1 through 21.

Clause 38: An apparatus for wireless communication at a wireless communication device, comprising a processor; memory coupled with the processor; and instructions stored in the memory and executable by the processor to cause the apparatus to perform a method of any of clauses 22 through 34.

Clause 39: An apparatus for wireless communication at a wireless communication device, comprising at least one means for performing a method of any of clauses 22 through 34.

Clause 40: A non-transitory computer-readable medium storing code for wireless communication at a wireless communication device, the code comprising instructions executable by a processor to perform a method of any of clauses 22 through 34.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a wireless communication device, comprising:
a processor;
memory coupled with the processor; and
instructions stored in the memory and executable by the processor to cause the apparatus to:
receive information associated with a reinforcement learning model, wherein the reinforcement learning model is associated with performing a distributed channel access procedure at the wireless communication device in a wireless local area network in accordance with the information; and
transmit a protocol data unit in accordance with the distributed channel access procedure and during a slot that is based at least in part on an output of the reinforcement learning model.

2. The apparatus of claim 1, wherein the instructions to receive the information associated with the reinforcement learning model are executable by the processor to cause the apparatus to:
receive an indication that the wireless communication device is allowed to develop the reinforcement learning model and use the reinforcement learning model for the distributed channel access procedure.

3. The apparatus of claim 2, wherein the instructions are further executable by the processor to cause the apparatus to:
develop the reinforcement learning model at the wireless communication device in accordance with receiving the indication that the wireless communication device is allowed to develop the reinforcement learning model.

4. The apparatus of claim 1, wherein the instructions to receive the information associated with the reinforcement learning model are executable by the processor to cause the apparatus to:
receive a configuration associated with the reinforcement learning model and an indication of whether the wireless communication device is allowed to retrain the reinforcement learning model for the distributed channel access procedure, wherein the instructions are further executable by the processor to cause the apparatus to:
selectively retrain the reinforcement learning model based at least in part on whether the wireless communication device is allowed to retrain the reinforcement learning model.

5. The apparatus of claim 1, wherein the instructions to receive the information associated with the reinforcement learning model are executable by the processor to cause the apparatus to:
receive an indication that the wireless communication device is allowed to retrain the reinforcement learning model for the distributed channel access procedure, wherein the reinforcement learning model is pre-loaded at the wireless communication device, wherein the instructions are further executable by the processor to cause the apparatus to:
retrain the reinforcement learning model based at least in part on the wireless communication device being allowed to retrain the reinforcement learning model.

6. The apparatus of claim 1, wherein the instructions are further executable by the processor to cause the apparatus to:
receive an indication that the wireless communication device is allowed to use the reinforcement learning model to obtain one or more of a transmission probability, a backoff counter, a duration of a contention window, or one or more parameters associated with the duration of the contention window, wherein the output of the reinforcement learning model includes the transmission probability, the backoff counter, the duration of a contention window, or the one or more parameters associated with the duration of the contention window.

7. The apparatus of claim 1, wherein the instructions to receive the information associated with the reinforcement learning model are executable by the processor to cause the apparatus to:
receive an indication of a policy associated with training or retraining the reinforcement learning model, wherein the instructions are further executable by the processor to cause the apparatus to:
train or retrain the reinforcement learning model in accordance with the policy.

8. The apparatus of claim 1, wherein the instructions to receive the information associated with the reinforcement learning model are executable by the processor to cause the apparatus to:
receive an indication of one or more parameters associated with a reinforcement learning technique that the wireless communication device is to follow when training or retraining the reinforcement learning model, wherein the reinforcement learning technique is associated with a Q learning technique, a policy gradient, an actor-critic technique, or a contextual multi-armed bandit (MAB) or context-less MAB technique, wherein the instructions are further executable by the processor to cause the apparatus to:
train or retrain the reinforcement learning model in accordance with the one or more parameters associated with the reinforcement learning technique.

9. The apparatus of claim 1, wherein the instructions to transmit the protocol data unit in accordance with the distributed channel access procedure and during the slot that is based at least in part on the output of the reinforcement learning model are executable by the processor to cause the apparatus to:
attempt to transmit the protocol data unit during one or more idle slots in accordance with a transmission probability, wherein the transmission probability is the output of the reinforcement learning model.

10. The apparatus of claim 1, wherein the instructions to transmit the protocol data unit in accordance with the distributed channel access procedure and during the slot that is based at least in part on the output of the reinforcement learning model are executable by the processor to cause the apparatus to:
transmit the protocol data unit during the slot in accordance with an expiration of a backoff counter, wherein the backoff counter is the output of the reinforcement learning model.

11. The apparatus of claim 1, wherein the instructions to transmit the protocol data unit in accordance with the distributed channel access procedure and during the slot that is based at least in part on the output of the reinforcement learning model are executable by the processor to cause the apparatus to:
transmit the protocol data unit during a contention window, wherein a duration of the contention window is associated with the output of the reinforcement learning model.

12. The apparatus of claim 1, wherein the instructions are further executable by the processor to cause the apparatus to:
derive one or more rewards associated with the reinforcement learning model in accordance with one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, wherein the output of the reinforcement learning model is based at least in part on the one or more rewards.

13. The apparatus of claim 1, wherein the instructions are further executable by the processor to cause the apparatus to:
obtain an updated state associated with the wireless communication device in accordance with transmitting the protocol data unit;
input, into the reinforcement learning model, the updated state to obtain an updated output of the reinforcement learning model; and
transmit a second protocol data unit in accordance with the distributed channel access procedure and during a second slot that is based at least in part on the updated output of the reinforcement learning model.

14. An apparatus for wireless communication at a wireless communication device, comprising:
a processor;
memory coupled with the processor; and
instructions stored in the memory and executable by the processor to cause the apparatus to:
transmit information associated with a reinforcement learning model, wherein the reinforcement learning model is associated with performing a distributed channel access procedure at a second wireless communication device in a wireless local area network in accordance with the information; and
receive, from the second wireless communication device, a protocol data unit in accordance with the distributed channel access procedure and during a slot that is based at least in part on an output of the reinforcement learning model.

15. The apparatus of claim 14, wherein the instructions to transmit the information associated with the reinforcement learning model are executable by the processor to cause the apparatus to:
transmit an indication that the second wireless communication device is allowed to develop the reinforcement learning model and use the reinforcement learning model for the distributed channel access procedure.

16. The apparatus of claim 14, wherein the instructions to transmit the information associated with the reinforcement learning model are executable by the processor to cause the apparatus to:
transmit information associated with the reinforcement learning model and an indication of whether the second wireless communication device is allowed to retrain the reinforcement learning model for the distributed channel access procedure.

17. The apparatus of claim 14, wherein the instructions to transmit the information associated with the reinforcement learning model are executable by the processor to cause the apparatus to:
transmit an indication that the second wireless communication device is allowed to retrain the reinforcement learning model for the distributed channel access procedure, wherein the reinforcement learning model is pre-loaded at the second wireless communication device.

18. The apparatus of claim 14, wherein the instructions to transmit the information associated with the reinforcement learning model are executable by the processor to cause the apparatus to:
transmit an indication of one or more parameters associated with a reinforcement learning technique that the second wireless communication device is to follow when training or retraining the reinforcement learning model, wherein the reinforcement learning technique is associated with a Q learning technique, a policy gradient, an actor-critic technique, or a contextual multi-armed bandit (MAB) or context-less MAB technique.

19. The apparatus of claim 14, wherein the instructions to transmit the information associated with the reinforcement learning model are executable by the processor to cause the apparatus to:
transmit an indication of one or more rewards associated with the reinforcement learning model, wherein the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, and wherein the output of the reinforcement learning model is based at least in part on the one or more rewards.

20. The apparatus of claim 14, wherein the instructions are further executable by the processor to cause the apparatus to:
transmit an indication of one or more parameters associated with an environment of the second wireless communication device, wherein the output of the reinforcement learning model is associated with a use of the one or more parameters as inputs into the reinforcement learning model.

21. A method for wireless communication at a wireless communication device, comprising:
receiving information associated with a reinforcement learning model, wherein the reinforcement learning model is associated with performing a distributed channel access procedure at the wireless communication device in a wireless local area network in accordance with the information; and
transmitting a protocol data unit in accordance with the distributed channel access procedure and during a slot that is based at least in part on an output of the reinforcement learning model.

22. The method of claim 21, wherein transmitting the protocol data unit in accordance with the distributed channel access procedure and during the slot that is based at least in part on the output of the reinforcement learning model comprises:
attempting to transmit the protocol data unit during one or more idle slots in accordance with a transmission probability, wherein the transmission probability is the output of the reinforcement learning model.

23. The method of claim 21, wherein transmitting the protocol data unit in accordance with the distributed channel access procedure and during the slot that is based at least in part on the output of the reinforcement learning model comprises:
transmitting the protocol data unit during the slot in accordance with an expiration of a backoff counter, wherein the backoff counter is the output of the reinforcement learning model.

24. The method of claim 21, wherein transmitting the protocol data unit in accordance with the distributed channel access procedure and during the slot that is based at least in part on the output of the reinforcement learning model comprises:
transmitting the protocol data unit during a contention window, wherein a duration of the contention window is associated with the output of the reinforcement learning model.

25. The method of claim 21, wherein receiving the information associated with the reinforcement learning model comprises:
receiving an indication of one or more rewards associated with the reinforcement learning model, wherein the one or more rewards include one or more of a signal-to-interference-plus-noise ratio, a throughput metric, a delay metric, a quantity of collisions, a ratio between a quantity of successful protocol data unit transmissions and a total quantity of protocol data unit transmissions, or a ratio between a quantity of unsuccessful protocol data unit transmissions and the total quantity of protocol data unit transmissions, and wherein the output of the reinforcement learning model is based at least in part on the one or more rewards.

26. The method of claim 21, further comprising:
receiving an indication of one or more parameters associated with an environment of the wireless communication device, wherein the output of the reinforcement learning model is associated with a use of the one or more parameters as inputs into the reinforcement learning model.

27. A method for wireless communication at a wireless communication device, comprising:
transmitting information associated with a reinforcement learning model, wherein the reinforcement learning model is associated with performing a distributed channel access procedure at a second wireless communication device in a wireless local area network in accordance with the information; and
receiving, from the second wireless communication device, a protocol data unit in accordance with the distributed channel access procedure and during a slot that is based at least in part on an output of the reinforcement learning model.

28. The method of claim 27, wherein transmitting the information associated with the reinforcement learning model comprises:
transmitting an indication that the second wireless communication device is allowed to develop the reinforcement learning model and use the reinforcement learning model for the distributed channel access procedure.

29. The method of claim 27, wherein transmitting the information associated with the reinforcement learning model comprises:
transmitting information associated with the reinforcement learning model and an indication of whether the second wireless communication device is allowed to retrain the reinforcement learning model for the distributed channel access procedure.

30. The method of claim 27, wherein transmitting the information associated with the reinforcement learning model comprises:
transmitting an indication that the second wireless communication device is allowed to retrain the reinforcement learning model for the distributed channel access procedure, wherein the reinforcement learning model is pre-loaded at the second wireless communication device.
